(19) United States
(12) Patent Application Publication
(10) Pub. No.: US 2016/0165898 A1
(43) Pub. Date: Jun. 16, 2016

(54) NATURAL BIOHERBICIDES AND RELATED MATERIALS AND METHODS

(71) Applicant: OHIO STATE INNOVATION FOUNDATION, Columbus, OH (US)

(72) Inventors: Hannah Mary Mathers, Columbus, OH (US); Luke Thomas Case, Sherwood, OH (US)

(73) Assignee: Ohio State Innovation Foundation, Columbus, OH (US)

(21) Appl. No.: 14/894,669

(22) PCT Filed: May 30, 2014
(86) PCT No.: PCT/US14/40344

§ 371 Date: Jan. 8, 2016

Related U.S. Application Data
(60) Provisional application No. 61/939,931, filed on Feb. 14, 2014.
(60) Provisional application No. 61/828,928, filed on May 30, 2013.

(51) Int. Cl. A01N 65/08

(52) U.S. Cl. CPC A01N 65/08

(57) ABSTRACT

Methods and compositions for environmentally-friendly weed control are provided. In particular, bioherbicide compositions are provided comprising plant extracts selected from Russian Olive, Austrian Pine, Tree of Heaven, Autumn Olive, and Black Walnut extract, either alone, or combination with at least one mulching substrate. Methods of using the herbicide compositions are also provided.

### CROSS REFERENCE TO RELATED APPLICATIONS

This application claims the benefit of U.S. Provisional Application Ser. No. 61/828,928 filed May 30, 2013 and U.S. Provisional Application Ser. No. 61/939,931 filed Feb. 14, 2014.

### BACKGROUND OF THE INVENTION

Public concern in the United States and the rest of the world is rising over the use of landscape pesticides, creating a problem for the nursery and landscape industry. Many European countries, Canadian provinces, and some US municipalities have enacted bans on the use of herbicides and cosmetic pesticides. The nursery and landscape industry have seen their profits decline by 50% in two years following the ban. This industry generates about $147.8 billion in revenue, 1.9 million jobs, and has an annual payroll of nearly $3 billion in the United States. A decline in the nursery and landscape industry could have drastic economic impacts.

Weed control is the number one issue of pest control facing the nursery and landscape industry when pesticides are banned. There are three reasons why weed control has become a leading issue in nursery and ornamental landscape use. First, fewer herbicides are being registered for ornamental use. This is largely due to chemical company fears of reapplication onto stock, increased irrigation water restrictions, and the necessity of recirculation ponds in container nursery culture. Second, herbicide registrations will be lost due to the new Food Quality Protection Act. Reduced herbicide registrations will have a greater impact on the ornamental industry than the loss of fungicide or insecticide registrations. Weed control becomes the major issue when chemical controls are taken out of the management strategy. Third, the cost of weed control using chemical applications plus hand weeding is already the largest pest management cost landscapers encounter in their ornamental operations. These factors result in increased costs, reduced efficiency of weed control, and decreased customer satisfaction.

The environmental impact of over reliance on chemical herbicide applications warrants consideration of alternative methods for weed control. The environmental impact includes unwanted damage to desired plants, contamination of ground water, and selection for weed resistance. The increased financial and environmental concerns have fueled considerable research to find ways of reducing amounts of herbicides used, while maintaining profitable crop production and attractive landscapes. Various approaches have been examined, including using below-label application rates, choosing the proper time and method of application, and adding surfactants or other additives. Nevertheless, more effective and environmentally-friendly approaches to weed control are needed.

### SUMMARY OF THE INVENTION

The present disclosure provides compositions and methods for providing safer, effective, and optionally organic weed control. The effectiveness of bioherbicide-treated inorganic or organic substrates (e.g. mulches) in controlling weeds is described herein.

The present invention provides methods to make an herbicidal extract, comprising: agitating pulverized allelopathic plant solids in organic solvent, so as to obtain an herbicidal slurry; and removing the plant solids from the herbicidal slurry, so as to obtain an herbicidal extract.

Also provided are such methods, wherein agitating is accomplished at least intermittently for at least approximately 24 hours.

Also provided are such methods, wherein the percentage of plant solids, by weight of the solids compared to the volume of the solvent, is selected from the group consisting of: about 5% w/v to about 30% w/v; about 10% w/v to about 20% w/v; about 20% w/v; about 10% w/v; about 6% w/v; and about 5% w/v.

Also provided are such methods, wherein the pulverized plant solids are selected from one or more of the group consisting of: ground plant parts; broken plant parts; crushed plant parts; macerated plant parts; and chipped plant parts.

Also provided are such methods, wherein the plant solids are plant material selected from the group consisting of: Russian Olive; Tree of Heaven; Autumn Olive; and Black Walnut.

Also provided are such methods, wherein the plant solids are plant material from at least two types of plants selected from the group consisting of: Russian Olive; Tree of Heaven; Autumn Olive; and Black Walnut.

Also provided are such methods, wherein the plant solids are plant material from at least three types of plants selected from the group consisting of: Russian Olive; Tree of Heaven; Autumn Olive; and Black Walnut.

Also provided are such methods, wherein the plant solids comprise plant material from Russian Olive; Tree of Heaven; Autumn Olive; and Black Walnut.

Also provided are such methods, wherein the organic solvent is one or more organic solvent selected from the group consisting of: ethanol; methanol; propanol; butanol; 2-propanol; 2-butanol; 2-methyl-2-propanol; glycerine; glycols; acetone; tetrahydrofuran; acetonitrile; 1,4-dioxane, pyridine; dimethylsulfoxide; N,N-dimethyl formamide; acetic acid; diethyl ether; hexane; heptanes; dichloromethane; ethyl acetate; ethylene glycol; propylene glycol; diethylene glycol; dipropylene glycol; and 1,3-butylene glycol.

Also provided are such methods, wherein removing the plant solids is accomplished according to a method selected from the group consisting of: purification; filtration; partial filtration; evaporation; and distillation.

Also provided are such methods, which further comprise a step selected from the group consisting of: reducing, drying, evaporating, dessicating, foaming; or otherwise increasing the relative concentration of the herbicidal extract in a formulation.

Also provided are such methods, which further comprise a step selected from the group consisting of: diluting; foaming; or otherwise decreasing the relative concentration of the herbicidal extract in a formulation.

Also provided are such methods, which further comprise a step of applying the herbicidal extract to a plant or plant environment.

Also provided are such methods, which further comprise a step of introducing at least one herbicidal extract to an organic or inorganic substrate, so as to obtain an herbicidal mulch.

Also provided are such methods, wherein the substrate is selected from the group consisting of: pine straw; shredded pine; pine nuggets; pine needles; shredded hardwood bark; chipped hard wood; ground rubber; plastic mats; shredded hard wood; shredded licorice root; shredded wood waste; shredded cedar; cedar chips; pine bark; shredded wood and bark; chipped wood and bark; sawdust; ground rubber; grass clippings; leaves; straw; hay; compost; newspaper; ground plastic; plastic sheeting; landscape fabric; volcanic lapilli; clay; shells; rocks; stones; gravel; plastic mulches; crushed lava rocks or bricks; landscape fabrics; geo textiles; crushed or tumbled glass; and synthetic materials.

The present invention also provides extracts made by a method herein.

The present invention also provides mulches made by a method herein.

The present invention also provides herbicidal extracts comprising an herbicidally-effective amount of at least one plant extract selected from the group consisting of: Russian Olive extract; Austrian Pine extract; Tree of Heaven extract; Autumn Olive extract; and Black Walnut extract.

Also provided are such extracts, which further comprise at least one organic or inorganic substrate selected from the group consisting of: pine straw; shredded pine; pine nuggets; pine needles; shredded hardwood bark; chipped hard wood; ground rubber; plastic mats; shredded hard wood; shredded licorice root; shredded wood waste; shredded cedar; cedar chips; pine bark; shredded wood and bark; chipped wood and bark; sawdust; ground rubber; grass clippings; leaves; straw; hay; compost; newspaper; ground plastic; plastic sheeting; landscape fabric; volcanic lapilli; clay; shells; rocks; stones; gravel; plastic mulches; crushed lava rocks or bricks; landscape fabrics; geo textiles; crushed or tumbled glass; and synthetic materials.

Also provided are such extracts, which further comprise one or more herbicides selected from the group consisting of: vinegar; 200 grain vinegar; Weed Pharm™; Scythe™; Engage; Broadstar™; Munger Horticultural Vinegar Plus; SureGuard®; Ronstar®; Biathlon®; Dacthal®; Devrinol®; dichlobenil; dithiopyr; Eptam®; FreeHand®; Gallery™; Granular Herbicide 75; Image®; Jewel®; Kerb®; Marengo®; OH2®; oryzalin; oxadiazon; oxyfluorfen; pendimethalin; Pennant Magnum®; PrePair®; prodiamine; RegalStar® II; Showcase®; simazine; Tower®; trifluralin; XL®; corn gluten; clove oil; thyme oil; and citric acid.

Also provided are such extracts, wherein the herbicidal plant extract is in a formulation selected from the group consisting of: aqueous media; non-aqueous media; foam; dust; wettable powder; emulsifiable concentrate; granule; and impregnated on at least one organic or inorganic substrate.

The present invention also provides methods of controlling weeds in a weed environment, comprising applying an herbicidal plant extract herein to a weed environment.

The present invention also provides methods of controlling weeds in a weed environment, comprising applying an herbicidal mulch herein to a weed environment.

The present invention provides an herbicidal plant extract comprising an herbicidally-effective amount of at least one plant extract selected from Russian Olive extract, Austrian Pine extract, Tree of Heaven extract, Autumn Olive extract, Black walnut extract, and combinations thereof.

Also provided is an herbicidal plant extract comprising an herbicidally-effective amount of Russian Olive plant extract.

Also provided is such an herbicidal plant extract further comprising an herbicidally-effective amount of an Austrian Pine plant extract.

Also provided is such an herbicidal plant extract, further comprising an herbicidally-effective amount of a Tree of Heaven plant extract.

The present invention also provides an herbicidal plant extract comprising an herbicidally-effective amount of an Austrian Pine plant extract.

Also provided is such an herbicidal plant extract, further comprising an herbicidally-effective amount of a Tree of Heaven plant extract.

The present invention also provides an herbicidal plant extract comprising an herbicidally-effective amount of a Russian Olive plant extract, an Austrian Pine plant extract, and a Tree of Heaven plant extract.

The present invention also provides an herbicidal plant extract comprising an herbicidally-effective amount of an Autumn Olive plant extract.

The present invention also provides an herbicidal plant extract comprising an herbicidally-effective amount of an Austrian Pine plant extract and a Black Walnut plant extract.

Also provided are such herbicidal plant extracts, further comprising at least one organic or inorganic substrate.

Also provided are such herbicidal plant extracts, wherein the at least one organic or inorganic substrate is selected from the group consisting of pine straw, shredded pine, pine nuggets, pine needles, shredded hardwood bark, chipped hard wood, sawdust, ground rubber, and plastic mats, shredded hard wood, shredded licorice root, shredded wood waste, shredded cedar, cedar chips, pine bark, shredded wood and bark, chipped wood and bark, sawdust, ground rubber, grass clippings, leaves, straw, hay, compost, newspaper, ground plastic, plastic sheeting, and landscape fabric, volcanic lapilli, clay, shells, rocks, stones, gravel, plastic mulches, crushed lava rocks or bricks, landscape fabrics, geo textiles, crushed or tumbled glass, and synthetic materials.

Also provided are such herbicidal plant extracts, wherein the size of the at least one organic or inorganic substrate selected form the group consisting of less than approximately 1 inch square, approximately 0.5 inch square to approximately 1 inch square, approximately 1 inch square to approximately 2 inch square, and greater than approximately 2 inch square.

Also provided are such herbicidal plant extracts, wherein the at least one organic or inorganic substrate is chipped or shredded hardwood.

Also provided are such herbicidal plant extracts, wherein the Russian Olive plant extract is at a concentration selected from the group consisting of about 5% w/v to about 30% w/v, about 10% w/v to about 20% w/v, and about 10% w/v.

Also provided are such herbicidal plant extracts, wherein the Austrian Pine plant extract is at a concentration selected from the group consisting of about 5% w/v to about 30% w/v, about 10% w/v to about 20% w/v, about 20% w/v, and about 5% w/v.

Also provided are such herbicidal plant extracts, wherein the Tree of Heaven plant extract is at a concentration selected from the group consisting of about 5% w/v to about 30% w/v, about 10% w/v to about 20% w/v, and about 10% w/v.

Also provided are such herbicidal plant extracts, wherein the Autumn Olive plant extract is at a concentration selected from the group consisting of about 5% w/v to about 30% w/v, about 10% w/v to about 20% w/v, and about 6% w/v.

Also provided are such herbicidal plant extracts, wherein the Black Walnut plant extract is at a concentration selected from the group consisting of about 5% w/v to about 30% w/v, about 10% w/v to about 20% w/v, about 20% w/v, and about 5% w/v.

The invention also provides for an herbicidal plant extract comprising a Russian Olive plant extract at a concentration of about 10% w/v, an Austrian Pine plant extract at a concentration of about 20% w/v, and a Tree of Heaven plant extract at a concentration of about 10% w/v.

The invention also provides for a composition comprising a Russian Olive plant extract at a concentration of about 10% w/v, an Austrian Pine plant extract at a concentration of about 20% w/v, a Tree of Heaven plant extract at a concentration of about 10% w/v, and at least one organic or inorganic substrate.

Also provided is a composition comprising an Austrian Pine plan extract at a concentration of about 5% w/v, a Black Walnut plant extract at a concentration of about 5% w/v, and at least one organic or inorganic substance.

Also provided is a composition comprising an Autumn Olive plant extract at a concentration of about 6% w/v and at least one organic or inorganic substrate.

Also provided are such herbicidal plant extracts, further comprising one or more herbicides selected from the group consisting of vinegar, 200 grain vinegar, Weed Pharm™ Scythe™, Engage, Broadstar™, Munger Horticultural Vinegar Plus, SureGuard®, Ronstar®, Biathlon®, Dacthal®, Devrinol®, dichlobenil, dithiopyr, Eptam®, FreeHand®, Gallery™, Granular Herbicide 75, Image®, Jewel®, Kerb®, Marengo®, OH2®, oryzalin, oxadiazon, oxyfluorfen, pendimethalin, Pennant Magnum®, PrePair®, prodiamine, RegalStar® II, Showcase®, simazine, Tower®, trifluralin, XL®, corn gluten, clove oil, thyme oil, and citric acid.

Also provided are such herbicidal plant extracts, wherein the herbicidal plant extract is in a formulation selected from the group consisting of aqueous media, non-aqueous media, foam, dust, wettable powder, emulsifiable concentrate, granule, and saturated with at least one organic or inorganic substrate.

The invention also provides an herbicidal mulch comprising at least one organic or inorganic substrate having an herbicidally-effective amount of a Russian Olive plant extract.

The invention also provides an herbicidal mulch comprising at least one organic or inorganic substrate impregnated with an herbicidally-effective amount of at least one plant extract selected from Austrian Pine extract, Russian Olive extract, Tree of Heaven extract, Autumn Olive extract, Black Walnut extract, and combinations thereof.

Also provides is an herbicidal mulch comprising at least one organic or inorganic substrate impregnated with an herbicidally-effective amount of an Austrian Pine plant extract.

The invention also provides for an herbicidal mulch comprising at least one organic or inorganic substrate impregnated with an herbicidally-effective amount of an Austrian Pine plant extract.

Also provided is such herbicidal mulches, further comprising an herbicidally-effective amount of a Tree of Heaven plant extract impregnated on the at least one organic or inorganic substrate

Also provided are such herbicidal mulches, wherein the amount of the Russian Olive and Tree of Heaven plant extract applied to the at least one organic or inorganic substrate is selected from the group consisting of about 465 mg/mm² to about 2790 mg/mm², about 930 mg/mm² to about 1860 mg/mm², and about 930 mg/mm².

Also provided are such herbicidal mulches, wherein the amount of the Austrian Pine extract applied to the organic or inorganic substrate is selected from the group consisting of about 465 mg/mm² to about 2790 mg/mm², about 930 mg/mm² to about 1860 mg/mm², about 1860 mg/mm², and about 460 mg/mm².

Also provided are such herbicidal mulches, wherein the amount of the Autumn Olive extract applied to the organic or inorganic substrate is selected from the group consisting of about 465 mg/mm² to about 2790 mg/mm², about 930 mg/mm² to about 1860 mg/mm², about 1860 mg/mm², and about 552 mg/mm².

Also provided are such herbicidal mulches, wherein the amount of the Black Walnut extract applied to the organic or inorganic substrate is selected from the group consisting of about 465 mg/mm² to about 2790 mg/mm², about 930 mg/mm² to about 1860 mg/mm², about 1860 mg/mm², and about 460 mg/mm².

Also provided are such herbicidal mulches, wherein the concentration of the herbicidal slurry is selected from the group consisting of about 50 g/L to about 300 g/L, about 100 g/L to about 200 g/L, about 200 g/L, and about 100 g/L.

Also provided are such herbicidal mulches, wherein the amount of the Russian Olive and Tree of Heaven plant extract introduced to the organic or inorganic substrate is selected from the group consisting of about 465 mg/mm² to about 2790 mg/mm², about 930 mg/mm² to about 1860 mg/mm², and about 930 mg/mm².

Also provided are such herbicidal mulches, wherein the amount of the Austrian Pine extract introduced to the organic or inorganic substrate is selected from the group consisting of about 465 mg/mm² to about 2790 mg/mm², about 930 mg/mm² to about 1860 mg/mm², and about 1860 mg/mm².

Also provided are such herbicidal mulches, wherein the amount of the Autumn Olive extract introduced to the organic or inorganic substrate is selected from the group consisting of about 465 mg/mm² to about 2790 mg/mm², about 930 mg/mm² to about 1860 mg/mm², and about 552 mg/mm².

Also provided are such herbicidal mulches, wherein the amount of the Black Walnut extract introduced to the organic or inorganic substrate is selected from the group consisting of about 465 mg/mm² to about 2790 mg/mm², about 930 mg/mm² to about 1860 mg/mm², and about 460 mg/mm².

Also provided are such herbicidal mulches, wherein the organic solvent is selected from the group consisting of ethanol, methanol, propanol, butanol, methanol, ethanol, propanal, butanol, 2-propanol, 2-butanol, 2-methyl-2-propanol, glycerine, glycols, acetone, tetrahydrofuran, acetonitrile, 1,4-dioxane, pyridine, dimethylsulfoxide, N,N-dimethyl formamide, acetic acid, diethyl ether, hexane, heptanes, dichloromethane, and ethyl acetate, ethylene glycol, propylene glycol, diethylene glycol, dipropylene glycol, and 1,3-butylene glycol.

The invention also provides a method of weed control, the method comprising applying the herbicidal mulches or plant extracts as described herein, to a plant growing environment.

Also provided are such methods, wherein application of the herbicidal mulch or plant extract has an effect selected from the group consisting of slowing or preventing growth of weeds, lowering reproductive capacity of weeds, preventing the introduction of undesirable plants, decreasing the likelihood of weed growth, and killing weeds.

### BRIEF DESCRIPTION OF THE FIGURES

The patent or application file may contain one or more drawings executed in color and/or one or more photographs. Copies of this patent or patent application publication with color drawing(s) and/or photograph(s) will be provided by the Patent Office upon request and payment of the necessary fee.

FIG. 1. Herbicide treated mulch efficacy trial at an outdoor geotextile covered growing area showing from left to right 25 conventional to bioherbicide mulch combinations in foreground. The phytotoxicity trial with the Euonymus fortunei ‘Emerald Gaiety’ is in the background. ARRPAC #1 (Tri-Tech Molded Products, Inc. McMinnville, Tenn. 37110), was used. A substrate of 60% composted softwood bark, 30% peat and 10% compost (Gro-Bark Ltd., Milton, ON). Picture taken 90 days after treatment (DAT).

FIG. 2. Efficacy and phytotoxicity combined over three species, Euonymus fortunei ‘Emerald Gaiety’ (Winter Creeper Euonymus), Sambuscus canadensis (American Elderberry) and Pinus Mugo (Mugo Pine) at Elev. 269 m, NE 43° 41.341′, WO79° 56.153′; 12688 10^{th} Line, Halton Hills, ON, 90 days after treatment. Two sizes of Pine bark (70% bark) (a composite of White pine, Red pine and Jack Pine) greater than 1 inch and less than 1 inch from Gro-Bark Ltd., Caledon, ON, SureGuard® and Ronstar® were used with the two barks or alone. Two bioherbicides [BH1 (or DU) and BH2 (or BS)] made from two plant extracts were applied at three concentrations (5%, 10% or 15%) to the two bark sizes and one 200 grain vinegar was also applied. Efficacy ratings of weed control 0 (no control) to 10 (complete control) and 7 (commercially acceptable—represented by top bar). Phytotoxicity visual ratings of 0 (no injury) to 10 (complete kill) are used.

FIG. 3. Efficacy of three conventional Ronstar® applications with pine bark compared to bioherbicide (BH2 or BS) and (BH1 or DU) at Elev. 269 m, NE 43° 41.341′, WO79° 56.153′; 12688 10^{th} Line, Halton Hills, ON, 90 days after treatment (DAT). Two sizes of Pine bark (70% bark) (a composite of White pine, Red pine and Jack Pine) greater than 1 inch and less than 1 inch from Gro-Bark Ltd., Caledon, ON, were used. The BH treatments were applied at three concentrations (5%, 10% or 15%) to the two bark sizes and one 200 grain vinegar was also applied. Efficacy ratings of weed control 0 (no control) to 10 (complete control) and 7 (commercially acceptable).

FIG. 4. Phytotoxicity species by treatment interaction for Euonymus fortunei ‘Emerald Gaiety’ (Winter Creeper Euonymus), Sambuscus canadensis (American Elderberry) and Pinus Mugo (Mugo Pine) at Elev. 269 m, NE 43° 41.341′, WO79° 56.153′; 12688 10th Line, Halton Hills, ON 90 days after treatment. Two sizes of Pine bark (70% bark) (a composite of White pine, Red pine and Jack Pine) greater than 1 inch and less than 1 inch from Gro-Bark Ltd., Caledon, ON, SureGuard® and Ronstar® were used with the two barks or alone. Two bioherbicides [BH1 (DU) and BH2(BS)] made from two plant extracts were applied at three concentrations (5%, 10% or 15%) to the two bark sizes and one 200 grain vinegar was also applied. Phytotoxicity visual ratings (Y axis) of 0 (no injury) to 10 (complete kill) are used less than 3 is commercially acceptable.

FIG. 5. The six most efficacious treatments applied at Elev. 269 m, NE 43° 41.341′, WO79° 56.153′; 12688 10^{th} Line, Halton Hills, ON 90 days after treatment compared to the control, no herbicide, no bark. Two sizes of Pine bark (70% bark) (a composite of White pine, Red pine and Jack Pine) greater than 1 inch and less than 1 inch from Gro-Bark Ltd., Caledon, ON, were used. The bioherbicide treatments (BH2 or BS) and (BH1 or DU) were applied at three concentrations (5%, 10% or 15%) to the two bark sizes and one 200 grain vinegar was also applied. Efficacy ratings of weed control 0 (no control) to 10 (complete control) and 7 (commercially acceptable).

FIGS. 6A-6C. FIG. 6A Three bark types, Hardwood bark (40% bark) (a composite of Oak, Poplar and Maple); FIG. 6B Cedar bark (bark and wood) (Eastern White Cedar); and FIG. 6C Pine bark (70% bark) (a composite of White pine, Red pine and Jack Pine) obtained from Gro-Bark Ltd., Caledon, ON laid out approximately one inch thick before application of bioherbicides.

FIG. 7. Shows presence of blown in weeds without the need for hand seeding weeds.

FIG. 8. Efficacy evaluations of three bark types, Pine bark (70% bark) (a composite of White pine, Red pine and Jack Pine); Hardwood bark (40% bark) (a composite of Oak, Poplar and Maple) and Cedar bark (bark and wood) (Eastern White Cedar) obtained from Gro-Bark Ltd., Caledon, ON at 50 days after treatment (DAT). The bioherbicide treatment (BH1 or DU) was applied at three concentrations (5%, 10% or 15%) to the three barks. Efficacy ratings of weed control 0 (no control) to 10 (complete control) and 7 (commercially acceptable).

FIGS. 9A-9B. FIG. 9A. 200 grain vinegar applied directly to soil surface (rating 3.6) 50 DAT compared to FIG. 9B. 200 grain vinegar applied on Hardwood bark (rating 7.4).

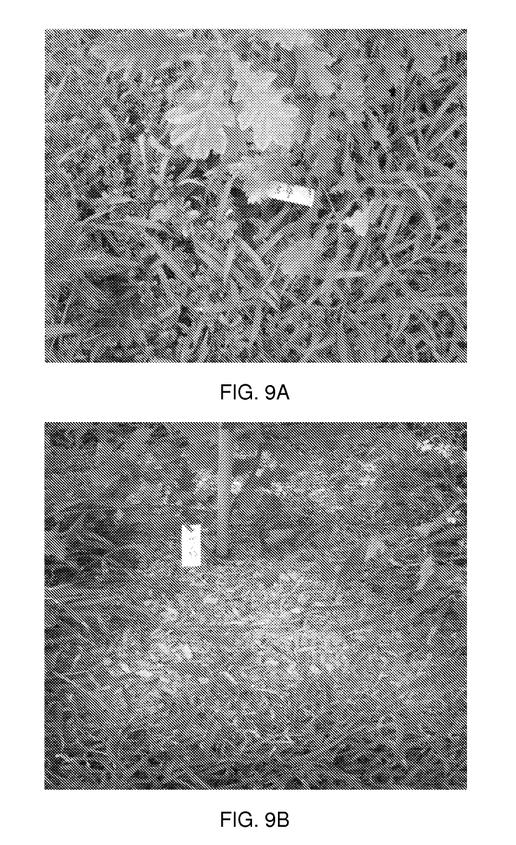

FIG. 10A-10B. FIG. 10A. Scythe™ applied directly to soil surface (rating 3.2) 50 DAT compared to FIG. 10B. Scythe™ applied on Hardwood bark (rating 8.4).

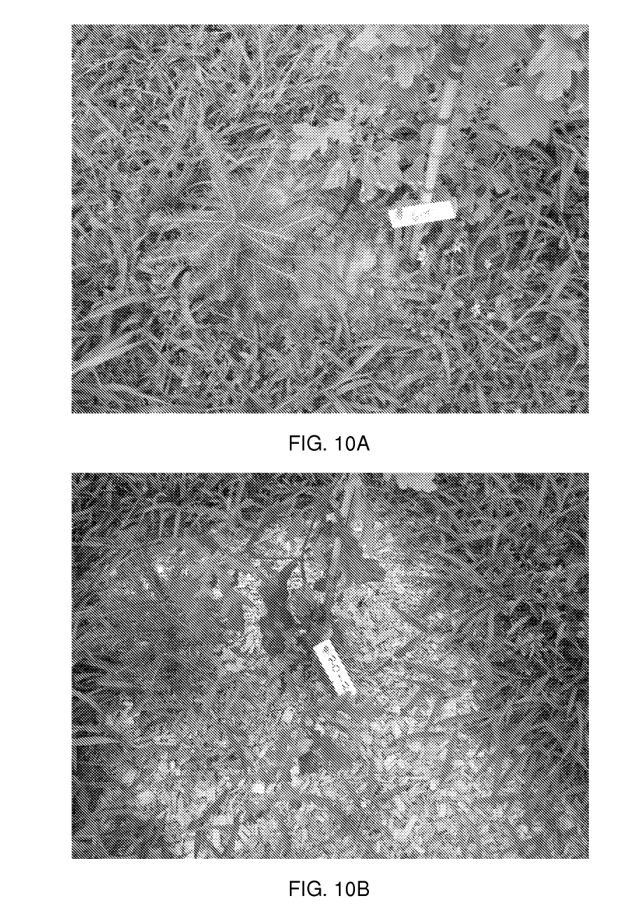

FIGS. 11A-11B. FIG. 11A. Layout of bioherbicide treatments on hardwood mulch at Halton Hills, Ontario, Calif. in Spirea field liner beds consisting of three rows across during Study 3. FIG. 11B. One gallon container trial also at Sheridan in Study 3 with Nine bark (Physocarpus opulifolious ‘Seward’), Summer Wine™ in background and Euonymus fortunei in the foreground.

FIGS. 12A-12B. FIG. 12A. Weed pressure at 40 days after treatment (DAT) in the liner beds where treatments were applied was extremely high compared to other rows where the standard preemergence herbicide (SureGuard®) 12 oz/ac had been applied in Study 3. FIG. 12B. Different view of the field.

FIG. 13. Results of field evaluations of bioherbicide treatments in Study 3 and phytotoxicity to Spirea japonica ‘Gold mound; 40 days after treatment (DAT). Efficacy is rated on a 10 point scale with 10 being perfect weed control and 7 and above commercially acceptable. Phytotoxicty is also rated on a 10 point scale; however, 10 indicates total death and 3 and below acceptable injury to the desired plant. Austrian Pine is labeled (DU), Eleagnus=(RO), Alianthos=(TH). Treatments labeled with the same letters are not significantly different at 0.05% lsd.

FIGS. 14A-14B. FIG. 14A. Nine Bark with treatment labels in front of pots (left-treatment 3) (100% WeedPharm™) (right-treatment 8) (100% Mungers) indicate severe stunting associated with 100% by volume applications compared to controls (to left and right, respectively of each). FIG. 14B. Euonymus with treatment labels on top of pots (left-treatment 12) (Control); (middle—treatment 8) (100% Mungers); (right—treatment 9) (BroadStar™).

FIGS. 15A-15B. FIG. 15A. Pinus nigra (Austrian Pine) 6% (left side) and Eleagnus angustifolia (Autumn olive) 6% (right side) both have a rating of 7.0 when picture was taken, (3 MAT) at Columbus, Ohio, bio-herbicide trial. FIG. 15B. Control with pine nuggets 3MAT (rating 2.8).

FIG. 16. Pinus nigra (Austrian Pine) 5%+5% Juglans nigra (Black walnut) a rating of 7.0 when picture was taken (3 MAT) at Columbus, Ohio, bio-herbicide trial.

FIG. 17. Table of the results of five allelopathic bio-herbicides compared to other organic herbicides and one synthetic herbicide applied on 2 inch pine nuggets (PN) or ½ cup of wood pellets (Pellets) evaluated over four dates in Columbus, Ohio. The trial was initiated in June.

FIG. 18. Picture of plot 65 DAT in Columbus Ohio treated with Freehand® at 150 lb/ac applied over the top of 2 inch pine nuggets.

### DETAILED DESCRIPTION OF THE INVENTION

The current invention provides compositions and methods for effective and environmentally-friendly weed control. The compositions comprise bioherbicides made from extracts from Austrian Pine, Russian Olive, Tree of Heaven, Autumn Olive, Black Walnut, and combinations thereof. The inventors have found these bioherbicides are as effective as commercial bioherbicides, with lower phytotoxicity ratings.

The bioherbicides of the invention may be applied directly to the planting area, or sprayed on mulch, creating an herbicidal mulch, which is subsequently added to the planting area. Mulch is commonly used in landscape and nursery beds throughout the United States, and can be organic (e.g. wood chips, leaves, bark, straw, etc.) or inorganic (e.g. landscape fabrics, plastics, rubber, stones, etc.). Application of bioherbicides directly to mulch serves as a carrier of the bioherbicides, helps conserve moisture in the soil, and further suppresses growth of weeds.

Application of the bioherbicides and herbicidal mulches of the current invention provides an environmentally-friendly and organic method of weed control. They have the effect of slowing or preventing growth of weeds, lowering reproductive capacity of weeds, preventing the introduction of undesirable plants, decreasing the likelihood of weed growth, and killing weeds.

With an increase in the public concern and regulation regarding the use of chemical and synthetic pesticides for ornamental use, the present invention provides the benefit of a safe, effective and environmentally-friendly method to control weed growth in nurseries and landscaping.

Allelopathy

Growth and development of plants are affected when exposed to allelochemicals. The readily visible effects include inhibited or retarded germination rates; darkened and swollen seeds; reduced root, radicle and shoot, or coleoptile extension; swelling or necrosis of root tips; curling of the root axis; discoloration; lack of root hairs; increased number of seminal roots; reduced dry weight accumulation; and lowered reproductive capacity. These gross morphological effects may be secondary manifestations of primary events, caused by a variety of more specific effects acting at the cellular or molecular level in the receiver plants. Extracts from plants have been used to utilize the properties of these allelochemicals, which have been used in herbicides, insecticides, fungicides, as well as medical applications.

The compositions and methods now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements.

Likewise, many modifications and other embodiments of the compositions and methods described herein will come to mind to one of skill in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

Compositions

The compositions of the present disclosure comprise an herbicidally-effective amount of at least one plant extract of Austrian Pine and/or Russian Olive, and optionally including an extract of Tree of Heaven. In one embodiment, the composition comprises an herbicidally-effective amount of at least one plant extract of Autumn Olive. In another embodiment, the composition comprises a plant extract from Austrian Pine and Black Walnut.

Austrian Pine

Austrian Pine (BH1 or DU—Pinus nigra), also called the European black pine, is a moderately variable species of pine, occurring across southern Mediterranean Europe from Spain to the Crimea, in Asia Minor and on Corsica/Cyprus, and in the high mountains of the Maghreb in North Africa.

Russian Olive

Russian Olive (RO—Elaeangus angustifolia), commonly called silver berry, oleaster, or wild olive, is a species of Elaeagnus, native to western and central Asia, from southern Russia and Kazakhstan to Turkey and Iran. It is now also widely established in North America as an introduced species.

Tree of Heaven

In another embodiment, the composition further comprises an herbicidally-effective amount of extract from Tree of Heaven (TH—Ailanthus altissima), commonly known as ailanthus, or in Standard Chinese as chouchun, which is a deciduous tree in the Simaroubaceae family. It is native to both northeast and central China and Taiwan. Unlike other members of the genus Ailanthus, it is found in temperate climates rather than the tropics.

Autumn Olive

Autumn Olive (Eleangus umbellata), also known as Japanese silverberry, umbellata oleaster, autumn elaeagnus, or spreading oleaster, is indigenous to eastern Asia and ranges from the Himalayas eastwards to Japan. Because it fixes atmospheric nitrogen in its roots, it often grows vigorously and competitively in infertile soils.

Black Walnut

Black Walnut (Juglans nigra), also called the eastern black walnut, is a species of flowering tree in the walnut family, Juglandaceae. Black Walnut is native to eastern North America. It grows mostly in riparian zones, from southern Ontario, west to southeast South Dakota, south to Georgia and northern Florida, and southwest to central Texas.

Additional Plant Sources of Bioherbicides

Additional plants that can be used to make extracts for use as bioherbicides include, but are not limited to, Horsetail (Equisetum arvense), Meadowfoam seed meal (Limnanthes alba), Yard-long bean [Vigna sesquipedalis (L.) Fruw], and Pondersoa pine (Pinus ponderosa).

TABLE 1
Ranges of % weight of pulverized plant
per volume of liquid compositions.

| | Concentration w/v | | | | |
|---|---|---|---|---|---|
| | Russian | Austrian | Tree of | Autumn | Black |
| | Olive | Pine | Heaven | Olive | Walnut |
| 1 | 5-30% | 0% | 0% | 0% | 0% |
| 2 | 5-30% | 5-30% | 0% | 0% | 0% |
| 3 | 5-30% | 5-30% | 5-30% | 0% | 0% |
| 4 | 10%-20% | 0% | 0% | 0% | 0% |
| 5 | 10%-20% | 10%-20% | 0% | 0% | 0% |
| 6 | 10%-20% | 10%-20% | 10-20% | 0% | 0% |
| 7 | ~10% | 0% | 0% | 0% | 0% |
| 8 | ~10% | ~20% | 0% | 0% | 0% |
| 9 | ~10% | ~20% | ~10% | 0% | 0% |
| 10 | 0% | 5-30% | 0% | 0% | 0% |
| 11 | 0% | 5-30% | 5-30% | 0% | 0% |
| 12 | 0% | 10%-20% | 0% | 0% | 0% |
| 13 | 0% | 10%-20% | 10-20% | 0% | 0% |
| 14 | 0% | ~20% | 0% | 0% | 0% |
| 15 | 0% | ~20% | ~10% | 0% | 0% |
| 16 | 0% | 0% | 0% | 5-30% | 0% |
| 17 | 0% | 0% | 0% | 10%-20% | 0% |
| 18 | 0% | 0% | 0% | ~6% | 0% |
| 19 | 0% | 5-30% | 0% | 0% | 5-30% |
| 20 | 0% | 10%-20% | 0% | 0% | 10%-20% |
| 21 | 0% | ~5% | 0% | 0% | ~5% |

TABLE 2
Range of weight(s) of allelopathic plant solids (grams) per volume of
organic solvent (liters) used in methods to make herbicidal extracts

Concentration (g/L)

| | Russian | Austrian | Tree of | Autumn | Black |
|---|---|---|---|---|---|
| | Olive | Pine | Heaven | Olive | Walnut |
| 1 | 50-300 | 0 | 0 | 0 | 0 |
| 2 | 50-300 | 50-300 | 0 | 0 | 0 |
| 3 | 50-300 | 50-300 | 50-300 | 0 | 0 |
| 4 | 100-200 | 0 | 0 | 0 | 0 |
| 5 | 100-200 | 100-200 | 0 | 0 | 0 |
| 6 | 100-200 | 100-200 | 100-200 | 0 | 0 |
| 7 | 100 | 0 | 0 | 0 | 0 |
| 8 | 100 | 200 | 0 | 0 | 0 |
| 9 | 100 | 200 | 100 | 0 | 0 |
| 10 | 0 | 50-300 | 0 | 0 | 0 |
| 11 | 0 | 50-300 | 50-300 | 0 | 0 |
| 12 | 0 | 100-200 | 0 | 0 | 0 |
| 13 | 0 | 100-200 | 100-200 | 0 | 0 |
| 14 | 0 | 200 | 0 | 0 | 0 |
| 15 | 0 | 200 | 100 | 0 | 0 |
| 16 | 0 | 0 | 0 | 50-300 | 0 |
| 17 | 0 | 0 | 0 | 100-200 | 0 |
| 18 | 0 | 0 | 0 | 60 | 0 |
| 19 | 0 | 50-300 | 0 | 0 | 50-3000 |
| 20 | 0 | 100-200 | 0 | 0 | 100-200 |
| 21 | 0 | 50 | 0 | 0 | 50 |

Definitions

As used herein, the term “herbicide” refers to molecules, combination of molecules, materials, combination of materials, or plant extracts that retards or otherwise kills undesirable, unwanted plants; such as, but not limited to, deleterious or annoying weeds, broadleaf plants, grasses, and sedges; and may be used in this manner for crop protection. By the term “herbicidally-effective amount” is meant any amount of herbicide necessary to produce an observable desired effect to reduce unwanted plant growth, including the effects of plant necrosis, plant death, growth inhibition, reproduction inhibition, inhibition of proliferation, and removal, destruction, or otherwise diminishing the occurrence and activity of undesirable, unwanted plants. Such controlling or modifying effects include all deviations from natural development, such as killing, retardation, defoliation, desiccation, regulation, stunting, tillering, stimulation, leaf burn, dwarfing and the like.

The term “extract” or “plant extract” as used herein means a substance or composition obtained from a plant or plant part source, regardless of whether the substance or composition is found external to the plant (i.e., an exudate), is found within the plant or plant part but external to the cells thereof, or is found within the cells of the plant. Chemical and/or physical action, as would be understood in the art, may be required to obtain the substance or composition from the plant or plant part.

The plant extract can be made by any method known in the art of preparing a plant extract. A common extraction method comprises mixing a pulverized plant with distilled water, alcohol, or organic solvent; fractionating the mixture; and removing the solvent. The alcohol can be, for example, ethanol, methanol, propanol or butanol. Exemplary liquid organic compounds that can be used as solvents in the extraction process to prepare the plant extracts include, but are not limited to, primary alcohols such as methyl alcohol (methanol), ethyl alcohol (ethanol), 1-propanol and 1-butanol; secondary alcohols such as 2-propanol and 2-butanol; tertiary alcohols such as 2-methyl-2-propanol; liquid polyhydric alcohols such as glycerine and glycols; and other known organic solvents such as acetone, tetrahydrofuran, acetonitrile, 1,4-dioxane, pyridine, dimethylsulfoxide, N,N-dimethyl formamide, acetic acid, diethyl ether, hexane, heptane, dichloromethane and ethyl acetate. Suitable glycols include, for example, ethylene glycol, propylene glycol, diethylene glycol, dipropylene glycol and 1,3-butylene glycol.

The plant extractions can be performed using any water-miscible solvent in a mixture with water, including, but not limited to acetone, alcohol, methylethylketone, ethyl acetate, and dimethylsulfoxide. Aqueous alcohol (alcohol/water) solutions are useful. A wide range of alcohol, or other solvents, to water ratios can be used. The solvent to water ratio can be 90:10, 80:20, 70:30, 60:40, 50:50, 40:60, 30:70, 20:80, 10:90, or intermediate ratios. The alcohol can be any alcohol, including methanol, ethanol, isopropyl alcohol, and n-propanol. In one embodiment, the alcohol is ethanol.

The plant material employed in the extraction process can be the entire plant, or it can be one or more distinct tissues from a plant, for example, leaves, flowers, roots, seeds, pods, stems, fruits, seed coats, buds, pine needles, or various combinations thereof. The plant material can be fresh, dried or frozen. The plant material may be used immediately after harvesting or it can be stored for a period of time prior to being subjected to the extraction process. If the plant material is stored, it can be treated prior to storage, for example, by drying, freezing, lyophilising, or some combination thereof. The storage time may be of various durations, for example, the storage period may be between a few days and a few years. Typically storage times range between about less than one week to about one year in duration.

Additional Ingredients

The composition of this disclosure, in addition to the plant extract herbicides alone or in combination, may also include one or more traditional herbicides, bioherbicides, pesticides, fertilizers, fungicides, antimicrobials, minerals, inert ingredients, etc., as well as one or more organic or inorganic substrates.

The compositions may include one or more inert ingredients. Such ingredients may include surfactants, dispersants, spreaders, stickers, antifoam agents, emulsifiers, and other similar materials such as those described in McCutcheon's Emulsifiers and Detergents, McCutcheon's Emulsifiers and Detergents/Functional Materials, and McCutcheon's Functional Materials, all published annually by McCutcheon Division of MC Publishing Company (New Jersey, USA). Inert ingredients may be added to the composition at the same time or in a separate impregnation step occurring before or after the herbicide or herbicides are impregnated on the substrate or in multiple impregnation steps occurring before, at the same time, and/or after the herbicide is impregnated on the substrate. This invention also contemplates compositions which include one or more additional herbicides, bioherbicides, allelopathic plant extracts and/or one or more fertilizing materials. Fertilizing materials may function as the substrate, may be impregnated on the substrate, or be separately added to the substrate.

The compositions may include one or more additional plant extracts containing herbicidal activity obtained from other allelopathic plants, including, but not limited to, black walnut, Leucaena, lantana, sour orange, red maple, swamp chesnut oak, sweet bay, red cedar, eucalyptus, neem trees, chaste tree, box elder, mango, rye, fescue, wheat, broccoli, jungle rice, forage radish, Jerusalem artichoke, Tifton burclover, sunn hemp, desert horspurslane, Rhazya stricta, rough cocklebur, garlic mustard, Barbados nut, chicory, swallow-worts, Vogel's tephrosia, green spurge, crabgrass, silver wattle, sticky snakeroot, Santa Maria feverfew, teak wood, and rabbitfoot grass.

The compositions may also be comprised of one or more additional compositions that have antifungal and antimicrobial activity. Fungicides in Plant Disease Control (Y. L. Nene and P. N. Thapliyal, International Science Publishers, New York, N.Y., USA, 1993) lists several fungicides useful in plant disease control. Preferably, an Organic Materials Review Institute (OMRI)-approved antifungal and antimicrobial agent would be used. OMRI-approved anti-fungal and anti-microbial products include, but are not limited to, actinovate SP, Cease™, Companion™, Contans WG™, copper fungicides, JMS Stylet-oil, Kaligreen™, KeyPlex305 OR, Mildew Cure, MilStop™, Organocide™, OxiDate™, Promax™, Proud-3™, Reglia SC™, Saf-T-Side™, Serenade Max™, Sonata™, Sporatec AG™, Sulfur fungicide, T-22 HC, Trilogy™, and Yeild Shield™. Additional plant extracts may also be included that have demonstrated anti-fungal activity, such as basil, marjoram, peppermint, and spearmint extracts.

Compositions can be formulated as a suspension or dispersion, in aqueous or non-aqueous media, as a foam, as a dust, as a wettable powder, as an emulsifiable concentrate, as a granule, impregnated on at least one organic or inorganic substrate, or as any of several other known types of formulations, depending on the desired mode of application. Compositions may be applied directly to soil, impregnated on at least one organic or inorganic substrate, and can be applied by any method known in the art, for example, but not limited to, spraying, pouring, dipping or the like. Additionally, the composition can be applied to an inorganic or organic substrate, and then applied to the planting area.

Inorganic and Organic Substrates

In another aspect, a composition is provided comprising an herbicidally-effective amount of at least one plant extract selected from Austrian Pine, Russian Olive, Tree of Heaven, Autumn Olive, Black Walnut, and combinations thereof, and at least one organic or inorganic substrate. The term “organic or inorganic substrate” in its broadest sense means any material spread over the ground that conserves moisture in soil, suppresses the growth of weeds, and can serve as a carrier for the herbicidal plant extracts. The organic or inorganic substrate can be mulch. Mulches can be organic or inorganic.

Organic Substrate

Organic substrate can be mulches derived from organic materials such as, for example, pine straw, shredded pine, pine nuggets, pine needles, shredded hardwood bark, chipped hard wood, sawdust, shredded hard wood, shredded licorice root, shredded wood waste, shredded cedar, cedar chips, pine bark, shredded wood and bark, chipped wood and bark, grass clippings, leaves, straw, hay, compost, newspaper, landscape fabric, volcanic lapilli, clay, shells and the like.

Inorganic Substrate

Inorganic mulches can include rocks, stones, gravel, plastic mulches, crushed lava rocks or bricks, landscape fabrics, geo textiles, crushed or tumbled glass, ground rubber, ground plastic, plastic sheeting, plastic mats or other synthetic materials. In addition, the substrate may be a combination of organic or inorganic substrates.

Mulching Compositions

In another aspect, a mulching composition is provided, comprising an herbicidally-effective amount of at least one plant extract impregnated on at least one inorganic or organic substrate. The composition may be comprised of an herbicidally-effective amount of extracts from Russian Olive or Austrian pine alone, or in combination, impregnated on at least one organic or inorganic substrate. In one embodiment, the mulch composition can comprise combinations of Russian Olive extract and/or Austrian Pine extract with Tree of Heaven extract, impregnated on a substrate. In another embodiment, the composition comprises Russian Olive extract and Tree of Heaven extract impregnated on a substrate. In another embodiment, the composition comprises Russian Olive extract and Austrian Pine extract impregnated on a substrate. In another embodiment, the composition comprises Austrian Pine extract and Tree of Heaven extract impregnated on a substrate. In another embodiment, the composition comprises Austrian Pine extract, Russian Olive extract and Tree of Heaven extract impregnated on substrate. In another embodiment, the composition comprises Autumn Olive extract impregnated on a substrate. In another embodiment, the composition comprises Austrian Pine extract and Black Walnut extract impregnated on a substrate.

In a further embodiment, the amount of Austrian Pine, Russian Olive, Tree of Heaven, Autumn Olive and Black Walnut extract impregnated on the at least one organic or inorganic substrate in mg extract per mm² of substrate is at least about 465 mg/mm² to about 2790 mg/mm² In another embodiment, the Austrian Pine, Russian Olive, Tree of Heaven, Autumn Olive and Black Walnut extract can be at a concentration of about 930 mg/mm² to about 1860 mg/mm² In an additional embodiment, the concentration of Austrian Pine extract is about 1860 mg/mm², the concentration of Russian Olive extract is about 930 mg/mm², the concentration of Tree of Heaven extract is about 930 mg/mm², the concentration of the Autumn Olive Extract is about 552 mg/mm², and the concentration of the Black Walnut and the Austrian Pine combination is 460 mg/mm² each (Table 3).

TABLE 3
Ranges of the concentration of plant extract impregnated on
the inorganic or organic substrate to form mulch composition.

| | Mulch composition | | | | |
|---|---|---|---|---|---|
| | (mg extract/mm² substrate) | | | | |
| | Russian | Austrian | Tree of | Autumn | Black |
| | Olive | Pine | Heaven | Olive | Walnut |
| 1 | 465-2790 | 0 | 0 | 0 | 0 |
| 2 | 465-2790 | 465-2790 | 0 | 0 | 0 |
| 3 | 465-2790 | 465-2790 | 465-2790 | 0 | 0 |
| 4 | 930-1860 | 0 | 0 | 0 | 0 |
| 5 | 930-1860 | 930-1860 | 0 | 0 | 0 |
| 6 | 930-1860 | 930-1860 | 930-1860 | 0 | 0 |
| 7 | 930 | 0 | 0 | 0 | 0 |
| 8 | 930 | 1860 | 0 | 0 | 0 |
| 9 | 930 | 1860 | 930 | 0 | 0 |
| 10 | 0 | 465-2790 | 0 | 0 | 0 |
| 11 | 0 | 465-2790 | 465-2790 | 0 | 0 |
| 12 | 0 | 930-1860 | 0 | 0 | 0 |
| 13 | 0 | 930-1860 | 930-1860 | 0 | 0 |
| 14 | 0 | 1860 | 0 | 0 | 0 |
| 15 | 0 | 1860 | 930 | 0 | 0 |
| 16 | 0 | 0 | 0 | 465-2790 | 0 |
| 17 | 0 | 0 | 0 | 930-1860 | 0 |
| 18 | 0 | 0 | 0 | 552 | 0 |
| 19 | 0 | 465-2790 | 0 | 0 | 465-2790 |
| 20 | 0 | 930-1860 | 0 | 0 | 930-1860 |
| 21 | 0 | 465 | 0 | 0 | 465 |

The compositions may also be impregnated with additional plant extracts with herbicidal activity, inert ingredients, herbicides, bioherbicides, biopesticides, fertilizers, anti-fungals, and anti-microbials, as described above.

In another aspect, a mulching composition is provided comprising at least one organic or inorganic substrate impregnated with a Tree of Heaven extract at a concentration of about 930 mg/mm², a Russian Olive extract at a concentration of about 930 mg/mm², and an Austrian Pine extract at a concentration of about 1860 mg/mm²

In another aspect, a mulching composition is provided comprising at least one organic or inorganic substrate impregnated with an Autumn Olive extract at a concentration of about 552 mg/mm²

In another aspect, a mulching composition is provided comprising at least one organic or inorganic substrate impregnated with an Austrian Pine extract at 460 mg/mm² and a Black Walnut extract at 460 mg/mm²

Process of Making Mulching Compositions

In another aspect, a mulching composition is provided, the mulching composition prepared by the process comprising combining pulverized plant selected from Russian Olive, Austrian Pine, Tree of Heaven, Autumn Olive, Black Walnut, or combinations thereof, with at least one organic solvent to form a solution, agitating the solution for at least 24 hours, filtering out the insoluble particulates, and impregnating at least one organic or inorganic substrate with an herbicidally-effective amount of the solution.

In one embodiment, the mulching composition is prepared by the process comprising combining pulverized Russian Olive plant with at least one organic solvent to form a solution, agitating the solution for at least 24 hours, filtering out the insoluble particulates, and impregnating at least one organic or inorganic substrate with an herbicidally-effective amount of the solution. In another embodiment, the mulch composition can be prepared by combining combinations of pulverized Russian Olive plant and/or Austrian Pine plant with pulverized Tree of Heaven plant. In one embodiment, the mulching composition comprises combining pulverized Russian Olive plant and Tree of Heaven plant to the organic solvent. In another embodiment, the composition comprises combining pulverized Russian Olive plant and Austrian Pine plant to the organic solvent. In another embodiment, the composition comprises combining pulverized Austrian Pine plant and Tree of Heaven plant. In another embodiment, the composition comprises combining pulverized Austrian Pine plant, Russian Olive plant and Tree of Heaven plant. In another embodiment, the composition comprises combining pulverized Autumn Olive plant. In another embodiment, the composition comprises combining pulverized Austrian Pine plant and Black Walnut plant. In another embodiment, the composition comprises combining pulverized Black Walnut plant.

The amount of pulverized plant added to a volume of the at least one organic solvent can be about 50 g/L to about 300 g/L, about 100 g/L to about 200 g/L, about 100 g/L, about 200 g/L, about 50 g/L, and about 60 g/L. The pulverized plant can be prepared by any method known in the art. The organic solvent can be any solvent known in the art for making plant extracts, as described above.

Plant extracts are formed following agitation for at least 24 hours of the pulverized plant-organic solvent solution and filtering of any insoluble particulates, followed by impregnation on at least one organic or inorganic substrate. The amount of plant extract impregnated on the substrate can be about 465 mg/mm² to about 2790 mg/mm², about 930 mg/mm² to about 1860 mg/mm², about 1860 mg/mm², about 930 mg/mm², about 552 mg/mm², and about 460 mg/mm² The organic or inorganic substrate may also be impregnated with additional ingredients as described above. The organic and inorganic substrate can be any one substrate or any combination of substrates, as described above.

In an another aspect, a method for weed control is provided comprising applying a mulching composition comprising at least one organic or inorganic substrate impregnated with an herbicidally-effective amount of at least one plant extract selected from Russian Olive extract and Austrian Pine extract. In an additional embodiment, the mulching composition is also impregnated with an herbicidally-effective amount of Tree of Heaven extract.

In an additional aspect, a method for weed control is provided comprising applying a composition comprising a Tree of Heaven extract at a concentration of 10% w/v, a Russian Olive extract at a concentration of 10% w/v, and an Austrian Pine extract at a concentration of about 20% w/v. In another embodiment, the composition includes at least one organic or inorganic substrate.

In a another aspect, a method of weed control is provided, the method comprising applying an herbicidally-effective amount of a plant extract to an organic or inorganic substrate, the plant extract selected from Russian Olive and Austrian Pine extract, and applying the herbicidally treated organic or inorganic substrate to a plant growing environment. In another embodiment, an herbicidally-effective amount of Tree of Heaven is also applied to the substrate.

In a final aspect, a method of weed control is provided, the method comprising applying any of the compositions described herein. In another embodiment, the application of the compositions described herein has an effect selected from slowing or preventing growth of weeds, lowering reproductive capacity of weeds, preventing the introduction of undesired plants, and killing weeds.

### EXAMPLES

The invention will be more fully understood upon consideration of the following non-limiting examples, which are offered for purposes of illustration, not limitation.

### Example 1

Extracts

Extracts of two allelopathic plants called bioherbicide (BH)1 (Austrian pine) (Pinus nigra) and BH2 (Blue Spruce) (Picea pungens) were prepared and applied at 5% and 10% aqueous solution. Branches were cut from trees on the Ohio State University (OSU) campus and branches and needles were ground using a laboratory mill After grinding, 10 g of ground plant samples were mixed with 50 mL of ethanol and shaken at 200 rpm for at least 24 hours using an electronic plate shaker. After shaking, the extracts were filtered using Whatmann #1 filter paper. Each process was repeated three times for each species, so a total of 3-50 mL extracts for each species was used to create 5%, 10% and 15% extracts (10 g/50 ml=20% w/v extracts):

5% of 100 ml=3 ml actual. 0.05/0.2×100=25 mL

10% of 100 mL=0.10/0.2 =50 mL

15% of 100 mL =0.15/0.2 =75 mL

### Example 2

Overview of the various studies to determine effects of herbicides on weed growth.

Materials and Methods

Evaluations were initiated and conducted at Halton Hills, Ontario, in one gallon containers, 75° F. in full sun, and at Vineland Station, ON, in 2 inch mulched 3×3 ft. plots at 80° F. in full sun (Study 1). Two sizes of Pine bark of greater than 1 inch and less than 1 inch were obtained from Gro-Bark Ltd., Caledon, ON. In another study three bark types were used: pine less than 1 inch, Hardwood (bark and wood), and Cedar (bark and wood) obtained from Gro-Bark Ltd (Study 2). In both studies bark was spread on plastic sheets at two inches thick, with five replications per treatment, and sprayed. In Study 1, the treated bark was allowed to stand for 24 hours and applied to the tops of freshly planted one-gallon containers. In Study 2, treatments were applied in situ over the of 3×3 ft. plots. In Study 1 oxadiazon (Ronstar®, Dow AgroSciences) and flumioxazin (BroadStar™, Valent USA) at 1× rates were used as industry standards for efficacy and phytotoxicity comparisons.

Results

In Study 1, phytotoxicity evaluations were conducted on white spruce (Picea gluaca), English oak (Quercus robur) and Coreopsis ‘Moonbeam.’ In Study 2, Euonymus fortunei ‘Emerald Gaiety’ (Winter Creeper Euonymus), Sambuscus canadensis (American Elderberry) and Pinus Mugo (Mugo Pine) were used. In Study 1, 200 grain vinegar (Ohio State University (OSU), Food Science Department) applied on less than 1 inch pine bark was as efficacious as the standard Ronstar® with less than half the phytotoxicity at 90 DAT. The plant extract BH1 (developed at OSU) at 5% and 10% on less than 1 inch bark was as efficacious as vinegar on less than 1 inch bark and the Ronstar®. However, the phytotoxicity with BH1 was almost half that of 200 grain vinegar and 3.5 times less than Ronstar®. In Study 2, further testing with horticultural vinegars compared to the OSU 200 grain, pelargonic acid (Scythe™ at 10% w/v, Gowan Co., LLC, Yuma, Ariz.) and comparisons of various mulch types were conducted. In Study 2, Munger Horticultural Vinegar Plus (MHVP) (20% acetic acid, Engage Agro, Guelph, ON) outperformed the 200 grain vinegar and WeedPharm™ (20% acetic acid) at 10% w/v (Pharm Solutions Inc., Port Townsend, Wash.). MHVP, Scythe™ and BH1 were the most efficacious treatments in Study 2. The vinegar, Scythe™ and BH1 were not efficacious when applied directly to soil. The three chemicals needed to be sprayed on the bark for commercial weed control levels to occur. In Study 3, field trials were conducted. In addition to BH1, two new plant extracts of 10% Russian olive (Eleagnus augustifolia) and 20% Tree of Heaven (Ailanthus altissima) were prepared (as per sample preparations in Study 1) and applied. New samples of BH 1 were not prepared for the Study 2 or Study 3. A marked decrease in efficacy with each study was attributed to sample deterioration in this period. Study 4 was conducted at the OSU 4-H building (a lead certified building, where no synthetic pesticides can be applied) and new solutions of BH1 evaluated.

### Example 3

Effects of herbicides on efficacy, phytotoxicity, and duration of weed control under various conditions.

Materials and Methods

Study 1 had two objectives: 1) determine the efficacy and duration of weed control of different control methods, including two barks sizes applied as a single layer on the container surfaces; and 2) assess the phytotoxicity of the different methods in containers.

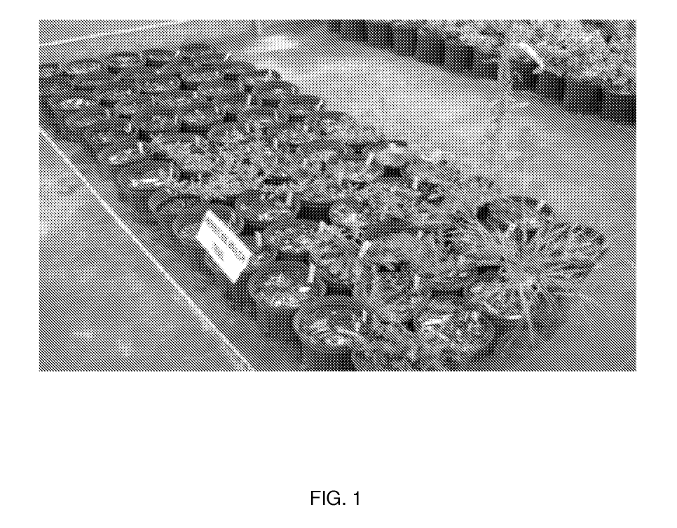

The study was conducted at Elev. 269 m, NE 43° 41.341′, WO79° 56.153′; 12688 10th Line, Halton Hills, ON, in one gallon containers on a sand pad overlaid with geotextile as part of the trial work (FIG. 1). The study was initiated in May and air temperatures were 75° F. Five single plant replications were conducted per treatment and species. The container species were Euonymus fortunei (‘Emerald Gaiety’ or Winter Creeper Euonymus), Sambuscus canadensis (American Elderberry) and Pinus Mugo (Mugo Pine). ARRPAC #1 (Tri-Tech Molded Products, Inc. McMinnville, Tenn. 37110) was used. A substrate of 60% composted softwood bark, 30% peat and 10% compost (Gro-Bark Ltd., Milton, ON) was used with incorporated or top-dressed, respectively, Polyon 20-6-13+minors (Agrium Advanced Technologies, Brantford, ON), 6 mo. formulation. Two sizes of Pine bark (70% bark) (a composite of White pine, Red pine and Jack Pine) of greater than 1 inch and less than 1 inch was obtained from Gro-Bark Ltd., Caledon, ON. The bark was sprayed over the top. The treated bark was then allowed to stand for 24 hours to absorb the chemicals and dry before applying to the test plants. Treated bark was applied directly over the top of freshly potted one-gallon plants in as close to a single layer as possible. Conventional herbicides, such as Ronstar®, were applied at 1.0 times the label rate of pounds of active ingredient per acre. The allelopathic chemicals were applied at 5% and 10% aqueous solution, prepared from two types of plants. A spray volume of 93 L/ha was used to apply with a CO2-pressurized backpack sprayer equipped with 8002 evs flat fan nozzles spaced 41 cm apart.

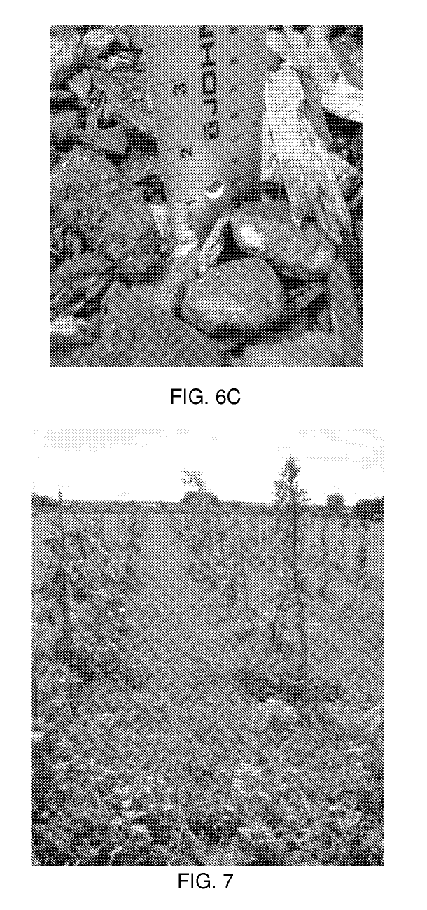

No seeding of weeds was conducted, since natural blow in of weed seeds was sufficient. Natural weed blow in and the existing propagule bank of perennial weeds such as Quackgrass resulted in high weed pressures in all plots (FIG. 7). Containers were arranged in a randomized complete block design with five replications, grouped by plant in the phytotoxicity trial and a CRD in the efficacy trial. Evaluations were conducted at 90 days after treatment (DAT) using a visual rating of weed control 0 (no control) to 10 (complete control) and 7 (commercially acceptable). Phytotoxicity evaluations were conducted 90 DAT. A visual rating score of 1 (no injury) to 10 (complete kill) was used. A total of 25 treatments were evaluated, six conventional, oxadiazon (Ronstar®) alone or with each bark size and flumioxazin (SureGuard®) applied alone or with each bark size. Seventeen of the treatments were bioherbicides composed of two plant extracts applied at three concentrations to the two bark sizes, and one with 200 grain vinegar. The two remaining treatments were combinations of bioherbicides and conventional herbicides applied to bark.

Results

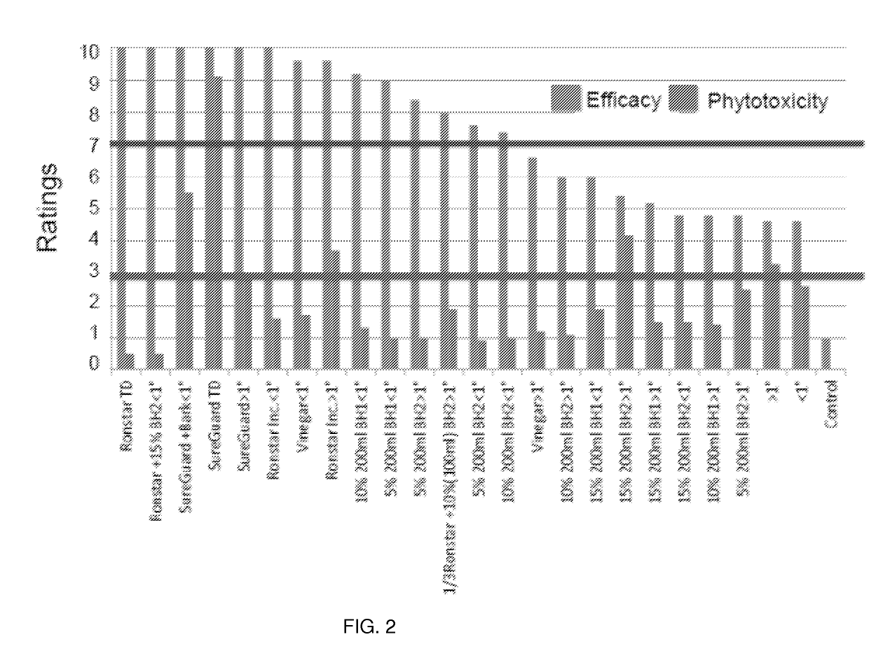

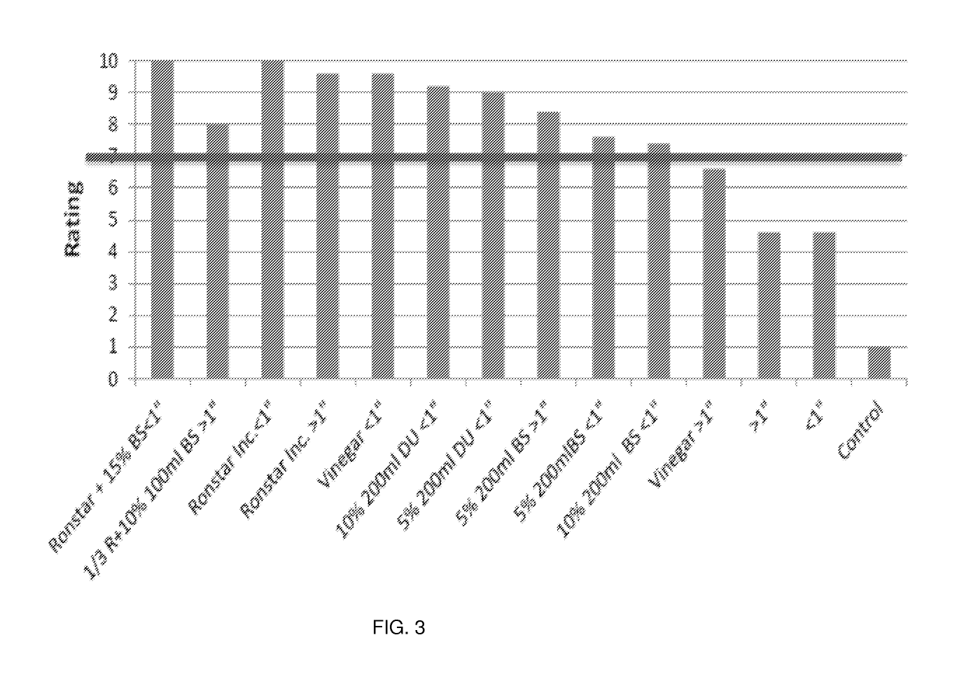

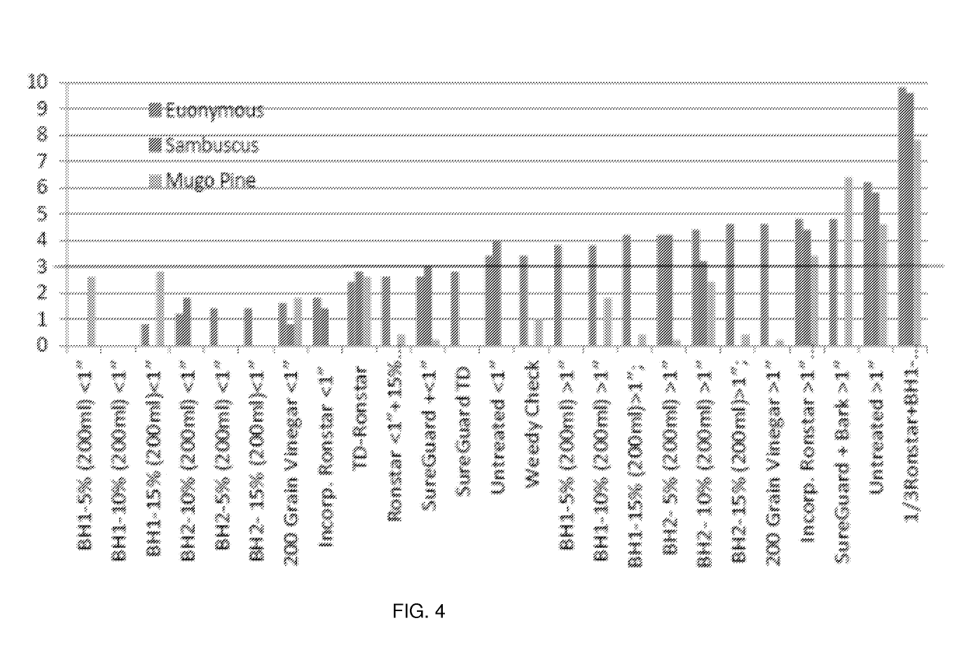

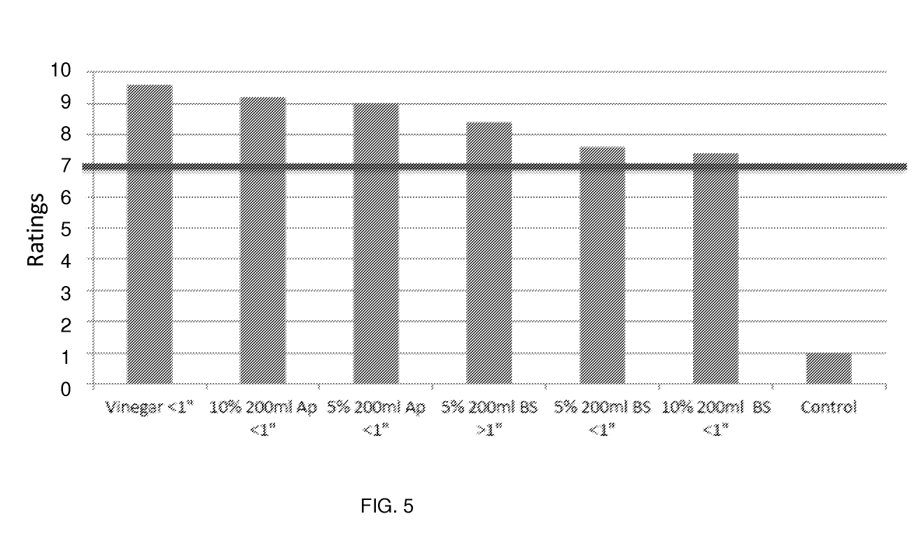

Fourteen of the 25 treatments evaluated provided efficacy ratings at or above the commercially acceptable value of greater than 7 (FIG. 2). Seven of these 14 were bioherbicide combinations with mulch, and one was a bioherbicide+Ronstar® mulch combination (FIG. 3). Three of the 14 treatments provided phytotoxicity ratings at or above commercially acceptable levels (FIG. 2). These three were all conventional herbicides: (SureGuard®) applied alone, SureGuard® on greater than 1 inch bark and Ronstar® on greater than 1 inch bark (FIG. 2). The greater than 1 inch bark was involved in 11 of the 13 highest phytotoxic treatments. There was a significant species by treatment interaction with Euonymus fortunei (‘Emerald Gaiety’) accounting for the majority of the phytotoxicity in the trial (FIG. 4). Even the untreated, greater than 1 inch bark had a rating of slightly above 3 combined over species (FIG. 2). It is believed that bark greater than 1 inch caused plants to be buried too deep as it contained an abundance of fine material. Eight of the bioherbicide combination provided phytotoxicity ratings of less than two (FIG. 2). The six most efficacious bioherbicide treated mulch combinations provided efficacy and phytotoxicity ratings of greater than 7 and less than 2, respectively, at 90 DAT (FIG. 5). The Vinegar on less than 1 inch pine bark was very efficacious and provided the same level of weed control as the conventional herbicide Ronstar®, with less than half the phytotoxicity at 90 DAT. The BH1 plant extract or DU 200 ml at 10% and 5% on less than 1 inch bark was statistically as efficacious as the Vinegar on less than 1 inch bark and the Ronstar®. However, the phytotoxicity with BH1 was less than half that of vinegar. The potential of vinegar and BH1 as bioherbicides combined with mulch, indicated further testing with different kinds of mulches are warranted.

The Vinegar on less than 1 inch pine bark was very efficacious and provided the same level of weed control as the conventional herbicide Ronstar®, with less than half the phytotoxicity at 90 DAT. The BH1 plant extract or DU 200 ml at 10% and 5% on less than 1 inch bark was statistically as efficacious as the Vinegar on less than 1 inch bark and the Ronstar®. However, the phytotoxicity with BH1 was almost half that of even vinegar and 3.5 times less than the Ronstar®. The potential of vinegar and BH1 as bioherbicides combined with mulch shown in this study indicated further testing with different kinds of mulches are warranted. In addition, the results warranted testing in a field setting to see the suitability in landscape or nursery field operations.

### Example 4

Efficacy and duration of weed control using various methods and compositions.

Materials and Methods

This study (Study 2) was designed to continue from the previous study (Study 1) with two objectives: 1) determine the efficacy and duration of weed control of different control methods in the field, including three bark types applied at 2 inch depth (Vineland Station, ON); and 2) assess the phytotoxicity of the different methods in the field. Only efficacy data is presented, as phytotoxicity was minimal

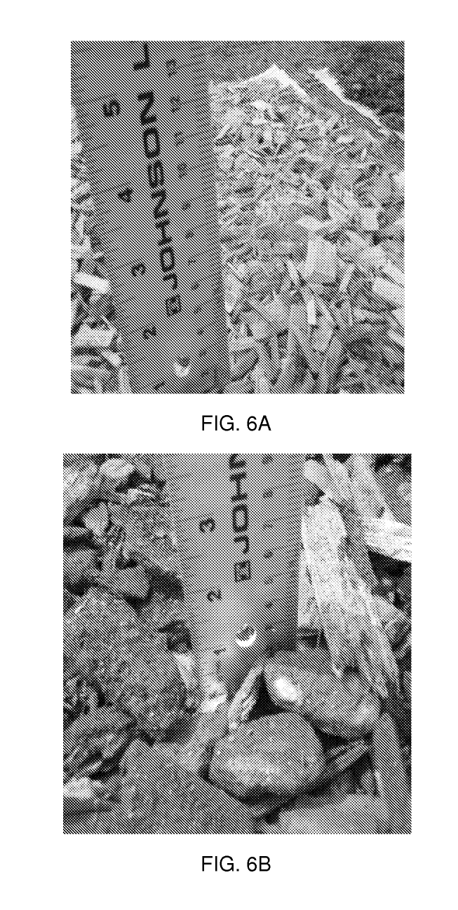

The research began in June and evaluations were conducted 35 DAT and 50 DAT. A controlled release fertilizer (CRF) Polyon 27-07-07 top dress+minors was used in field evaluations (Vineland Station, ON). Eight cubic yards of each of the three bark types, 2-3 inch Hardwood bark (40% bark) (a composite of Oak, Poplar and Maple), Cedar bark (bark and wood) (Eastern White Cedar), and Pine bark (70% bark) (a composite of White pine, Red pine and Jack Pine) were obtained from Gro-Bark Ltd., Caledon, ON (FIGS. 6A, B, and C, respectively). The bark was laid on the plots and sprayed over the top. The allelopathic chemicals of the BH1 extract were applied at 5% and 10% aqueous solution, prepared from the type used in the Study 1 (BH1). A spray volume of 93 L/ha was used to apply the chemicals with a CO₂-pressurized backpack sprayer equipped with 8002 evs flat fan nozzles spaced 41 cm apart. Two studies were conducted, one looking at efficacy and one phytotoxicity. The bark was applied directly over the top of freshly planted landscape beds at a depth of 2 inches. Each replicated and randomized bed contained three types of ornamental plants: white spruce (Picea gluaca) out of #2 containers, English oak (Quercus robur) out of #3 containers and Coreopsis ‘Moonbeam’ out of 4 inch pots. Plants were spaced on 1 inch centers. Standard nursery and landscape irrigation practices were employed for the duration of the study.

Natural blow in of weed seeds and the existing propagules of perennial weeds such as Quackgrass (Elytrigia repens) occurred and exerted high weed pressures in all plots (FIG. 7). Efficacy and phytotoxicity were rated as described in the previous study (Study 1). Each plot was a mulched area using pine, hardwood, or cedar in 3×3 ft. plots with 5 replications/ treatment. There were 28 treatments evaluated. Nine combinations of BH1 from Study 1 were applied (15%, 10% and 5%) to each of the three barks. The three barks were also applied alone for three additional treatments. Three kinds of vinegar were evaluated: 200 Grain Vinegar (similar to that used in the 2009 trial from the Ohio State University, Food Science Department); (20% acetic acid) WeedPharm™ at 10% w/v (Pharm Solutions Inc., Port Townsend, Wash.); and Munger Horticultural Vinegar Plus (20% acetic acid—Engage Agro, Guelph, ON). Each of these vinegars were applied either directly to the ground around the plants or onto the three bark types, with the exception of the Engage Agro product, which was not applied to the soil. There was a total of 11 treatments. Four treatments of pelargonic acid, Scythe™ at 10% w/v, (Gowan Co., LLC, Yuma, Ariz.) were also used on the three mulches and directly applied to the soil. In addition, a control of no mulch, no chemical was included, and the results evaluated.

Results

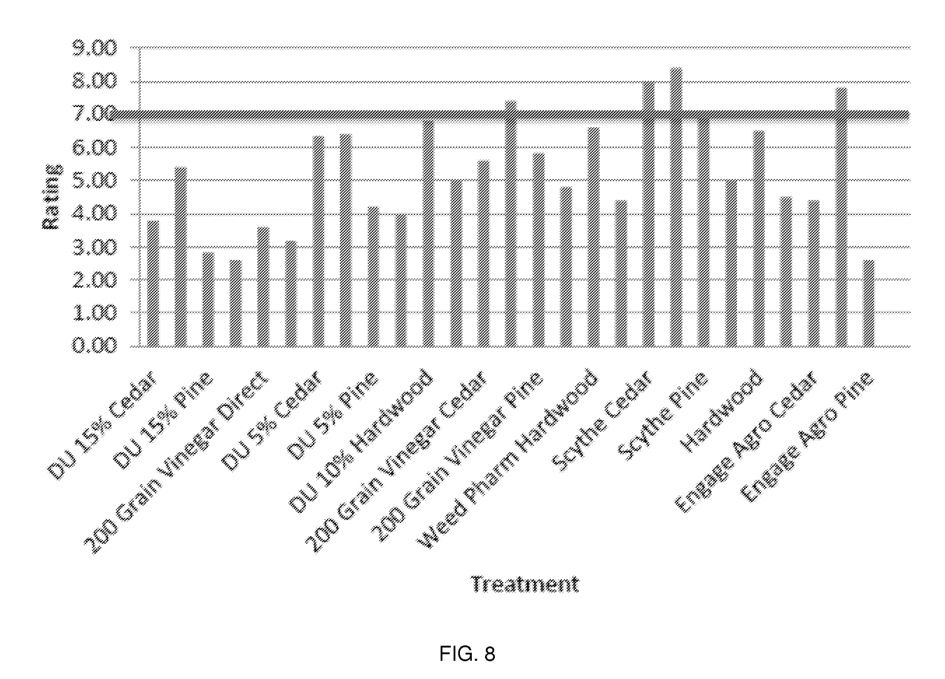

Five of 28 treatments evaluated provided efficacy ratings at or above commercially acceptable levels of greater than 7 (FIG. 8) at 50 DAT. 200 grain Vinegar on Hardwood bark, the Engage Agro vinegar on Hardwood, Scythe™ applied to any of the three barks with cedar or hardwood were slightly better performing than pine. The BH1 at 10% on hardwood from Study 1 had a rating of 6.8, which was not significantly different than the treatments with ratings of 7. At 35 DAT, the BH1 at 10% on hardwood had an efficacy rating of 7.0. The WeedPharm™, 200 grain vinegar and Scythe™ applied directly provided less than 50% of their efficacy than when combined with bark. At the initiation of the trial, it was assumed that the three horticultural vinegars would perform the same, since each consist of 20% acetic acid. However, at 35 and 50 DAT, there were significant differences in performance. The best horticultural vinegar is the Munger, especially with hardwood bark. The least efficacious vinegar with bark was the WeedPharm™. The performance of the Scythe™ as a bioherbicide combined with any bark type was a surprise. There was no previous evidence to indicate Scythe™ would combine well with bark to provide residual weed control. Although BH1 did not perform as well as in Study 1, it was still in the top six treatments for this study. The field conditions of Study 2 were a more stringent test for the bioherbicides than the containers of Study 1. Weed pressure was extremely high, as indicated by the control phytotoxicity rating at 50 DAT (3.4 rating). The BH1 at 10% on hardwood merits further testing in field conditions due to its performance in Study 1 and Study 2.

Of the six most efficacious treatments, only one, Scythe™ on pine, provided a phytotoxicity rating above commercially acceptable (less than 3). Six treatments total were phytotoxic (less than 3), WeedPharm™ direct, 200 grain vinegar direct, 10% BH1 on pine, 200 grain vinegar on cedar, and the control.

### Example 5

Effect of Russian Olive (RO), Tree of Heaven (TH), and Austrian Pine (BH1) on efficacy and phytoxocity of weed control compared to industry standards.

Materials and Methods

This study (Study 3) was established at 11874 10 Line, Halton Hills, ON L7G 2×1 Canada, in field liner beds of Spirea japonica (‘Gold mound’) in late June.

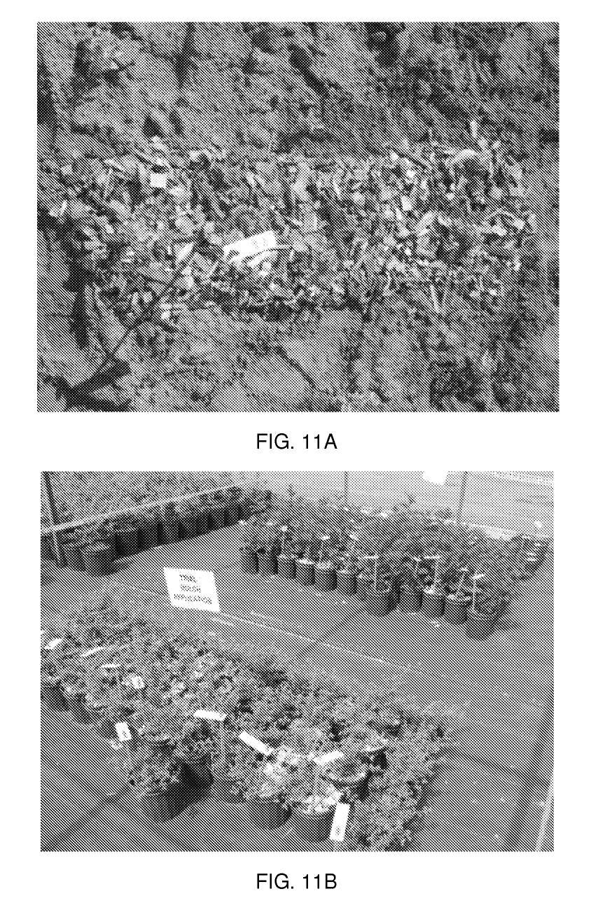

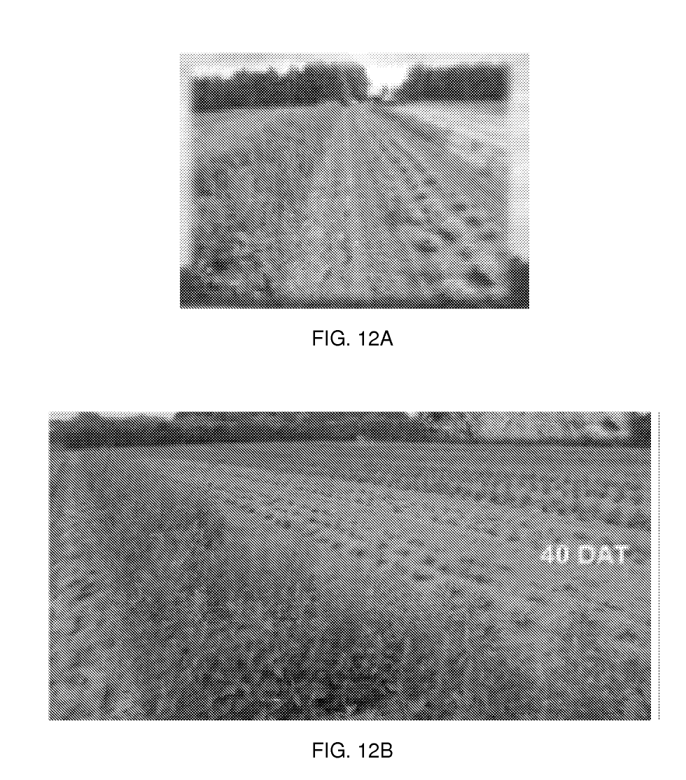

Conditions at the start of the trial were 75° F./24° C.; max wind 27 km/h over 60 sec; ay. wind 18.2 km/h over 60 sec; at moments 10.3 km/h. Trials in one gallon containers of Nine bark (Physocarpus opulifolious ‘Seward’), Summer Wine™ and Euonymus fortunei. Spirea liners were planted in three rows per bed. Rows were aligned north to south. Plants were not evenly set between rows (east and west). Individual treatment representatives were chosen where plants aligned ross rows (FIG. 11). In this way the mulch could be spread straight across all three rows. Each plot was weeded and the randomly assigned treatments were applied over the three rows as 12 inch bands (north/south) and three feet wide (east/west) (FIG. 11). Hardwood mulch was (donated by GroBark as in 2010) pre-treated (see treatments, below) in conditions of 70° F./21° C. and stored in black plastic bags. However, BroadStar™-treated mulch was not available. This treatment was applied using the same mulch as before and 4.6 g of BroadStar™ granules were spread over the weeded treatment area in the Sheridan Spirea liner beds and then topped with the hardwood mulch (FIG. 11). One evaluation was conducted at 40 DAT when weed pressure was very high (FIG. 12).

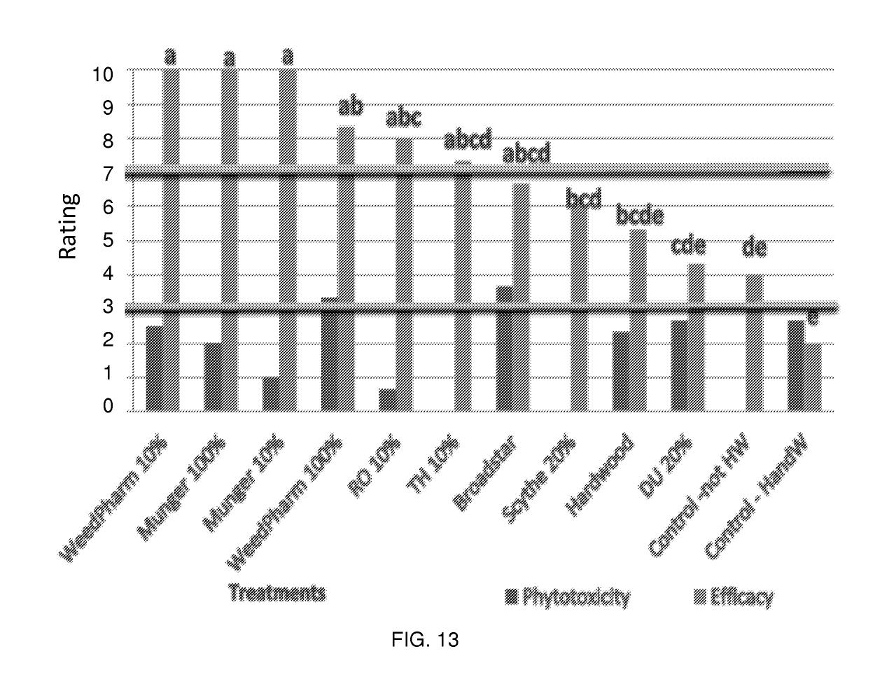

In all, 12 treatments were applied in each of the container and the field trials: Austrian Pine (DU or BH1), 20%; Russian Olive (RO), 10%; Weed Pharm™, 10%; Weed Pharm™, 100%; Ailonthos (TH), 20%; Scythe™, 20%; Munger Horticultural Vinegar Plus (Yucca Extract), 10%; Munger Horticultural Vinegar Plus (Yucca Extract), 100%; Broadstar™, 0.0102 lb/3 ft2=4.63 g or 1.2 teaspoon; Hardwood Mulch, two controls, hand-weeded (HW) initially, but not thereafter and HW after evaluations (FIG. 13). Both controls are the same because only one evaluation was conducted. Treatments 1-8 were flat-line sprayed onto hardwood mulch. All treatments (1-12) were weeded at application date.

Results

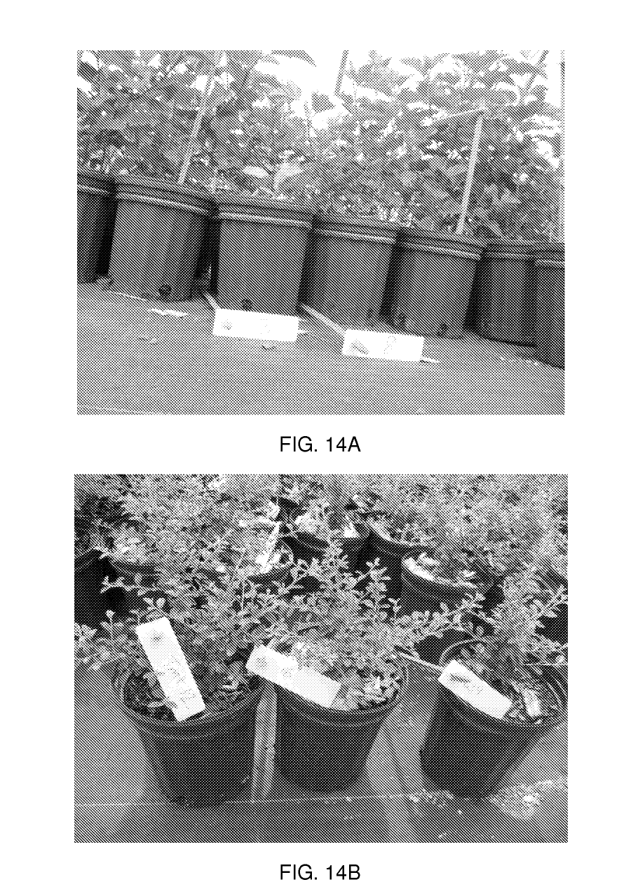

Spraying the vinegar at 10% or 100% by volume made no statistical difference on efficacy between the Munger or WeedPharm™ horticultural vinegars (FIG. 13). Ten percent by volume solutions of either vinegar provided perfect weed control at 40 DAT (FIG. 13). However, the use of 100% WeedPharm™ increased phytotoxicity to acceptable commercial levels across all species evaluated in the field (FIG. 13) and in containers (FIGS. 14A and B). In containers, 100% Mungers and WeedPharm™ caused unacceptable damage and stunting in Nine Bark (FIG. 14A) and Euonymus (FIG. 14B). However, Broadstar™ treatments were more phytotoxic to Euonymus than a 100% solution of Mungers (FIG. 14B).

The Russian olive extract provided a rating of 8 at 40 DAT and the Tree of Heaven extract a rating of 7.3. Both were providing commercially acceptable weed control in the field at 40 DAT. Both RO and TH were providing better efficacy than the commercial standard Broadstar™. The DU (BH1) was providing only slightly better efficacy than the controls at a rating of 4, because a solution prepared 2 years earlier was used.

The DU (BH1), RO and TH provided excellent efficacy compared to commercial standards in three years of testing. RO and TH provided excellent efficacy in one study (in both the field and in containers). All three plant extracts show effectiveness as non-synthetic herbicide alternatives in ornamental containers, nursery fields and landscapes. The DU extract also showed great selectivity on broadleaf weeds versus grasses, indicating testing as an alternative herbicide should be pursued in turf.

### Example 6

Effects of Autumn Olive (Eleangus umbellata), Blue Spruce, and Austrian Pine 30 Black Walnut (Juglans nigra) on efficacy of weed control compared to industry standards.

Materials and Methods

Branches were cut from trees on the OSU campus and then branches, needles, and bark were dried in a 32° C. dry oven for 1 week. The dried materials were then ground using a laboratory Wiley mill. After grinding, 20 g of grinds were mixed with 100 mL of ethanol and shaken at 200 rpm for at least 24 hours using an electronic plate shaker. After shaking, the extracts were filtered using Whatmann #1 filter paper and a vacuum pump. Ethanol was added back to replace the small amount of liquid lost at this stage and to recreate 100 ml solutions. This forms a stock solution and is a 20% w/v solution of the bio-herbicide (20 g per 100 ml=20% w/v). Different percentages were created by adding water to the 100 ml of stock solution. A 10% solution is 50 ml water and 50 ml of the stock solution. A 5% solution is 75 ml water and 25 ml of stock solution. This can be calculated (5% of 100 ml=0.05/0.2×100=25 mL) or (10% of 100 mL=0.10/0.2=50 mL) or (15% of 100 mL=0.15/0.2=75 mL). 6 small branches makes about 650 g or thirty two 100 mL 20% solutions, therefore, 6 small branches makes sixty four 10% solutions. For Blue Spruce, 75% of the material is in the 20% w/v solution. Table 6 shows some examples of small branch sizes, the wet weight, and the dry weight following drying for about 1 week.

TABLE 5
Concentration (mg of dry weight/ml of ethanol)
of plant extracts from three species.

| Species | mg/ml | S.E. |
|---|---|---|
| Ailanthus | 45 | 9.80 |
| Eleagnus | 31 | 2.67 |
| Picea | 50 | 4.44 |

Notes:
Each value represents the average of six replications. Five ml of the mixture dry plant material and 95% ethanol were placed in test tubes to estimate concentration of dry extracts. Ethanol was evaporated at 63 +/− 2 degrees Celsius.

TABLE 6
Fresh weight and size of small blue spruce plants
branches collected and placed in drying oven for
over 1 week and the dry weights after drying.

| Br. # | Max Length | Max Width | Fresh Weight (g) | Dry weight (g) |
|---|---|---|---|---|
| 1 | 2′ 4″ | 2′ 2″ | 272.0 | 138.34 |
| 2 | 2′ 3″ | 2′ 3″ | 199.6 | 109.82 |
| 3 | 2′ 10″ | 3′ 3″ | 227.11 | 134.82 |
| 4 | 2′ 3″ | 2′ | 227.3 | 118.97 |
| 5 | 1′ 10″ | 3′ 6″ | 388.15 | 192.51 |
| 6 | 2′ 2″ | 2′ 3″ | 180.5 | 97.36 |

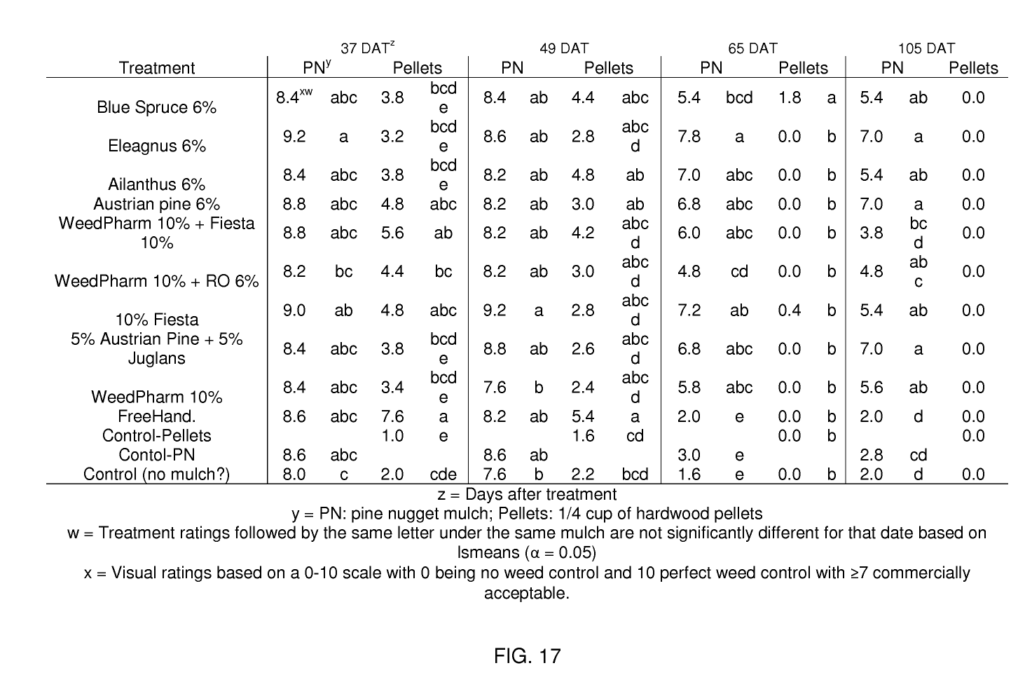

The research began in June and evaluations were conducted on 37 DAT, 49 DAT, 65 DAT, and 105 DAT. A controlled release fertilizer (CRF) Osmocote Pro 17-5-11 fertilizer as a top dress was used in the field evaluations. 3×3 ft. plots/treatment/replications were established that were mulched with pine nuggets at 2 inches deep and 3×3 ft. of half a cup of wood stove pellets per plots/ treatment/ replication treated. Mulch is commonly used in landscape beds throughout the US. The plots were established in Columbus, Ohio. Supplemental irrigation was provided in the first two weeks during establishment. However, all irrigation was discontinued after two weeks and only normal precipitation was provided. June and July were wetter than normal months in Columbus, Ohio, with increases of 1.39 inches of rain in June and 2.08 inches of rain in July over the 30 year average. August had 0.62 inches of rain and September had 1.36 inches of rain, drier than the 30 year average. To observe phytotoxicity, one tree, Freeman Maple (Acer Xfreemanii, J. Frank Schmidt Nursery, Boring, Oreg.) was used in each plot. The alleopathic chemicals were applied at 6% and 5% aqueous solution prepared from five types of plants (FIG. 17). A spray volume of 93 L/ha was used to apply chemicals, using a CO2-pressurized backpack sprayer equipped with 8002 evs flat fan nozzles spaced 41 cm apart.

Natural blow-in of weed seeds occurred and the existing propagules of perennial weeds such as Quackgrass (Elytrigia repens), Canada thistle (Cirsium arvense) and bindweed (Convolvulus arvensis) exerted high weed pressures in all plots. Efficacy was rated on a scale of 0-10, with 10 being perfect weed control, 0 being no control, and greater than 7 being commercially acceptable. There were 13 treatments evaluated with five replications per treatment. Two commercial bio-herbicide products were used as comparisons, 20% acetic acid, WeedPharm™ at 10% v/v (Pharm Solutions Inc., Port Townsend, Wash.) and Fiesta, Iron HEDTA 26.52% (Neudorff, North America) at 10% v/v. Each of these and the alleopathic plant extracts were applied either directly onto the bark mulch already spread on the ground, or to the wood pellets in a retractable roof house (FIG. 17). After the wood pellets were sprayed and dried for 24 hours, bagged, and half a cup of each was applied to the ground of the 3×3 ft. field plots.

Results

The use of bioherbicides with wood pellets as a carrier, applied at a rate of half a cup per 9 ft² plot, was ineffective in weed control. Even at 37 DAT, only one treatment, the synthetic, non-bioherbicide Freehand® at 37 DAT with ½ cup of wood pellets, provided commercially acceptable weed control (FIG. 17). The rate of half a cup of wood pellets was observed to be too low as all the pellets either blew off the plots or were washed away, leaving the product on the sites. Previous studies had used half a cup of pellets in gravel with success. However, in the field with no protection from wind and water by the irregular surfaces of a gravel site, the pellets did not persist. Higher rates of pellets are suggested. At 49 DAT, even Freehand® with wood pellets was no longer commercially acceptable. This lack of control with Freehand® at 49 DAT speaks to the tremendous weed pressure in the farm plots. Freehand® is one of the longest residual preemergence herbicide product currently available in the ornamental market. The manufacture indicates 150 days of weed control. However, all herbicides are dose responsive and when the propagule bank is acute, as it was in this trial, even products like Freehand® have their limits with weed control.

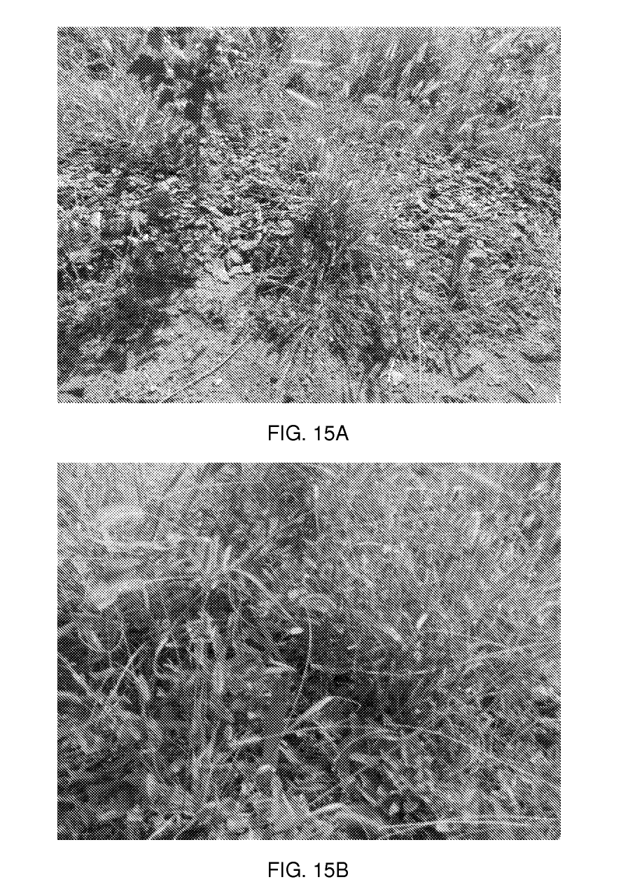

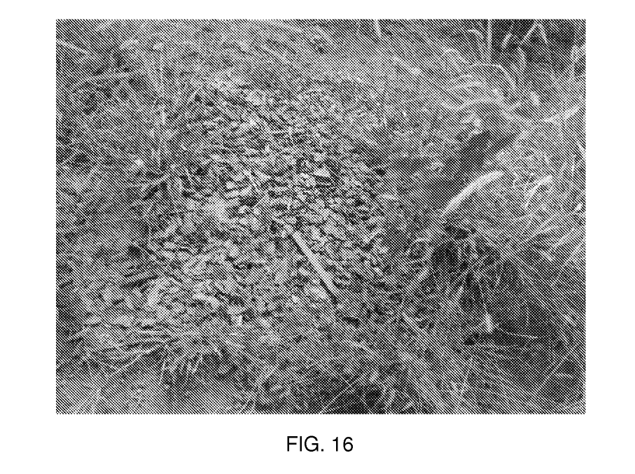

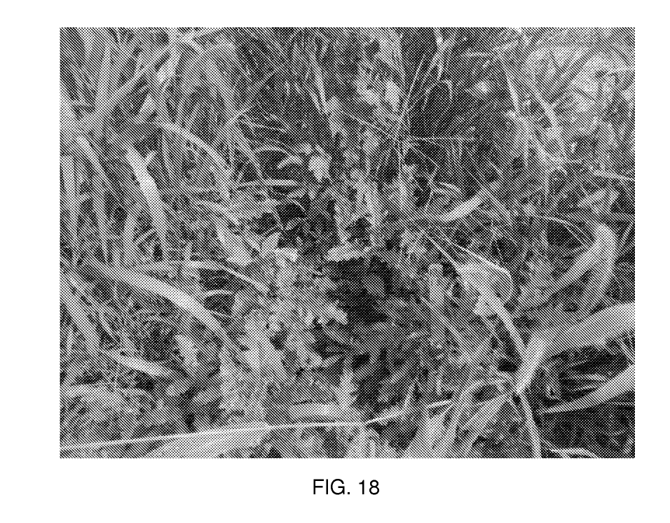

Conversely to the wood pellets, the use of bioherbicides with a carrier of 2 inch pine nuggets was effective. All treatments with the 2 inch pine nugget at 37 and 49 DAT were commercially acceptable (FIG. 17). At 65 DAT, five treatments, four of which were alleopathic plant extracts, had a commercially acceptable rating of greater than 7. The five treatments were 6% Eleagnus angustifolia (Autumn olive), 6% Ailanthus altissima (Tree of Heaven), 6% Pinus nigra (Austrian Pine), 10% Fiesta, and combination of 5% Austrian Pine and 5% Juglans nigra (Black Walnut) (FIG. 17). At 65 DAT, all pellet treatments were now offering no control. Freehand® with 2 inch mulch was also providing little control (2.0 rating) (FIG. 18). By 105 DAT, only three treatments evaluated provided efficacy ratings at or above commercially acceptable levels of greater than 7: 6% Eleagnus angustifolia, 6% Pinus nigra (FIG. 15A), and combination of 5% Pinus nigra and 5% Juglans nigra (FIG. 16). The 2 inch pine nuggets with no herbicide treatment were providing only 2.8 rating (FIG. 15B) at 3 MAT, which was statistically similar to the control with no mulch, no herbicide (FIG. 17).

Unless defined otherwise, all technical and scientific terms used herein have the same meaning as commonly understood by one of skill in the art to which the invention pertains. Although any methods and materials similar to or equivalent to those described herein can be used in the practice or testing of the present invention, the preferred methods and materials are described herein.

Various objects and advantages of this invention will become apparent to those skilled in the art from the above detailed description of the preferred embodiment, when read in light of the accompanying drawings.

What is claimed is:

1. A method to make an herbicidal extract, comprising:
a) agitating pulverized allelopathic plant solids in organic solvent, so as to obtain an herbicidal slurry;
b) removing the plant solids from the herbicidal slurry, so as to obtain an herbicidal extract.

2. A method of claim 1, wherein agitating is accomplished at least intermittently for at least approximately 24 hours.

3. A method of claim 1, wherein the percentage of plant solids, by weight of the solids compared to the volume of the solvent, is selected from the group consisting of: about 5% w/v to about 30% w/v; about 10% w/v to about 20% w/v; about 20% w/v; about 10% w/v; about 6% w/v; and about 5% w/v.

4. A method of claim 1, wherein the pulverized plant solids are selected from one or more of the group consisting of: ground plant parts; broken plant parts; crushed plant parts; macerated plant parts; and chipped plant parts.

5. A method of claim 1, wherein the plant solids are plant material selected from the group consisting of: Russian Olive; Tree of Heaven; Autumn Olive; and Black Walnut.

6. A method of claim 1, wherein the plant solids are plant material from at least two types of plants selected from the group consisting of: Russian Olive; Tree of Heaven; Autumn Olive; and Black Walnut.

7. A method of claim 1, wherein the plant solids are plant material from at least three types of plants selected from the group consisting of: Russian Olive; Tree of Heaven; Autumn Olive; and Black Walnut.

8. A method of claim 1, wherein the plant solids comprise plant material from Russian Olive; Tree of Heaven; Autumn Olive; and Black Walnut.

9. A method of claim 1, wherein the organic solvent is one or more organic solvent selected from the group consisting of: ethanol; methanol; propanol; butanol; 2-propanol; 2-butanol; 2-methyl-2-propanol; glycerine; glycols; acetone; tetrahydrofuran; acetonitrile; 1,4-dioxane, pyridine; dimethylsulfoxide; N,N-dimethyl formamide; acetic acid; diethyl ether; hexane; heptanes; dichloromethane; ethyl acetate; ethylene glycol; propylene glycol; diethylene glycol; dipropylene glycol; and 1,3-butylene glycol.

10. A method of claim 1, wherein removing the plant solids is accomplished according to a method selected from the group consisting of: purification; filtration; partial filtration; evaporation; and distillation.

11. A method of claim 1, which further comprises a step selected from the group consisting of: reducing, drying, evaporating, dessicating, foaming; or otherwise increasing the relative concentration of the herbicidal extract in a formulation.

12. A method of claim 1, which further comprises a step selected from the group consisting of: diluting; foaming; or otherwise decreasing the relative concentration of the herbicidal extract in a formulation.

13. A method of claim 1, which further comprises a step of applying the herbicidal extract to a plant or plant environment.

14. A method of claim 1, which further comprises a step of introducing at least one herbicidal extract to an organic or inorganic substrate, so as to obtain an herbicidal mulch.

15. A method of claim 14, wherein the substrate is selected from the group consisting of: pine straw; shredded pine; pine nuggets; pine needles; shredded hardwood bark; chipped hard wood; ground rubber; plastic mats; shredded hard wood; shredded licorice root; shredded wood waste; shredded cedar; cedar chips; pine bark; shredded wood and bark; chipped wood and bark; sawdust; ground rubber; grass clippings; leaves; straw; hay; compost; newspaper; ground plastic; plastic sheeting; landscape fabric; volcanic lapilli; clay; shells; rocks; stones; gravel; plastic mulches; crushed lava rocks or bricks; landscape fabrics; geo textiles; crushed or tumbled glass; and synthetic materials.

16. An extract made by a method herein.

17. A mulch made by a method herein.

18. An herbicidal extract comprising an herbicidally-effective amount of at least one plant extract selected from the group consisting of: Russian Olive extract; Austrian Pine extract; Tree of Heaven extract; Autumn Olive extract; and Black Walnut extract.

19. The herbicidal plant extract herein, further comprising at least one organic or inorganic substrate is selected from the group consisting of: pine straw; shredded pine; pine nuggets; pine needles; shredded hardwood bark; chipped hard wood; ground rubber; plastic mats; shredded hard wood; shredded licorice root; shredded wood waste; shredded cedar; cedar chips; pine bark; shredded wood and bark; chipped wood and bark; sawdust; ground rubber; grass clippings; leaves; straw; hay; compost; newspaper; ground plastic; plastic sheeting; landscape fabric; volcanic lapilli; clay; shells; rocks; stones; gravel; plastic mulches; crushed lava rocks or bricks; landscape fabrics; geo textiles; crushed or tumbled glass; and synthetic materials.

20. The herbicidal plant extract herein, further comprising one or more herbicides selected from the group consisting of: vinegar; 200 grain vinegar; Weed Pharm™; Scythe™; Engage; Broadstar™; Munger Horticultural Vinegar Plus; SureGuard®; Ronstar®; Biathlon®; Dacthal®; Devrinol®; dichlobenil; dithiopyr; Eptam®; FreeHand®; Gallery™; Granular Herbicide 75; Image®; Jewel®; Kerb®; Marengo®; OH2®; oryzalin; oxadiazon; oxyfluorfen; pendimethalin; Pennant Magnum®; PrePair®; prodiamine; RegalStar® II; Showcase®; simazine; Tower®; trifluralin; XL®; corn gluten; clove oil; thyme oil; and citric acid.

21. The herbicidal plant extract herein, wherein the herbicidal plant extract is in a formulation selected from the group consisting of: aqueous media; non-aqueous media; foam; dust; wettable powder; emulsifiable concentrate; granule; and impregnated on at least one organic or inorganic substrate.

22. A method of controlling weeds in a weed environment, comprising applying an herbicidal plant extract herein to a weed environment.

23. A method of controlling weeds in a weed environment, comprising applying an herbicidal mulch herein to a weed environment.
